(19) United States
(12) Patent Application Publication
(10) Pub. No.: US 2023/0359204 A1
(43) Pub. Date: Nov. 9, 2023

(54) FLIGHT CONTROL METHOD, VIDEO EDITING METHOD, DEVICE, UAV AND STORAGE MEDIUM

(71) Applicant: SZ DJI TECHNOLOGY CO., LTD., Shenzhen (CN)

(72) Inventors: Luoxiao QIN, Shenzhen (CN); Wei ZHANG, Shenzhen (CN); Yuqi LIU, Shenzhen (CN); Junbei SHANG, Shenzhen (CN)

(73) Assignee: SZ DJI TECHNOLOGY CO., LTD., Shenzhen (CN)

(21) Appl. No.: 18/215,729

(22) Filed: Jun. 28, 2023

Related U.S. Application Data
(63) Continuation of application No. PCT/CN2021/087612, filed on Apr. 15, 2021.
Application No. PCT/CN2021/087612 is a continuation of application No. PCT/CN2020/142023, filed on Dec. 31, 2020.

(51) Int. Cl. G05D 1/00; H04N 23/695; G05D 1/10

(52) U.S. Cl. CPC G05D 1/0094; H04N 23/695; G05D 1/101; B64U 10/13

(57) ABSTRACT

A flight control method, a video editing method, a device, a movable platform and a storage medium are provided. The method includes: obtaining a target flight trajectory of the movable platform, the target flight trajectory including a plurality of sub-trajectories, the plurality of sub-trajectories including an encircling sub-trajectory, a receding sub-trajectory, and/or an approaching sub-trajectory. The movable platform is controlled to fly according to the target flight trajectory, and a photographing on the movable platform is used to shoot a target photographing object. Thus, multiple videos corresponding to the plurality of sub-trajectories may be acquired within a single flight process.

### RELATED APPLICATIONS

This application is a continuation application of PCT application No. PCT/CN2021/087612, filed on Apr. 15, 2021, which claims the benefit of priority of PCT application No. PCT/CN2020/142023, filed on Dec. 31, 2020, and the contents of the foregoing documents are incorporated herein by reference in the entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present application relates to the technical field of movable platform, and in particular, relates to a flight control method, a video editing method, a device, a movable platform, and a storage medium.

### BACKGROUND

Movable platforms can be used to perform navigation, surveillance, reconnaissance and exploration missions for military and civilian applications. An unmanned aerial vehicle (UAV) is an example of a movable platform. Movable platforms may carry payloads, such as cameras, to perform specific functions, for example, capturing images and videos of the surrounding environment of a movable platform, tracking target objects moving on the ground or in the air, etc. Information used to control the movable platform is usually received by the movable platform from a terminal device (such as a remote controller) and/or determined by the movable platform.

An UAV is usually equipped with a photographing (shooting) device. When a user uses an UAV for video shooting, the user needs to operate a remote control to manually control the UAV and the photographing device, so as to adjust the shooting position and shooting angle and then perform shooting shot by shot. In this way, it would be difficult for novice users to capture good videos.

After shooting, users usually need to use certain video editing software for post-editing. Thus, users need to perform complicated operations that may consume a lot of time.

### SUMMARY

In light of the foregoing, one object of the present disclosure is to provide a flight control method, a video editing method, a device, a movable platform, and a storage medium.

In existing technologies, when a user uses a movable platform for video shooting, the user needs to operate a remote control to manually control the movable platform and the photographing device, so as to adjust the shooting position and shooting angle and then perform shooting shot by shot. In this process, it is necessary to perform parameter setting and real-time adjustment on certain devices such as the movable platform and the photographing device with the remote control. The control process is relatively complex. Thus, for a novice user who is not familiar with aerial photography, it may be difficult to determine satisfactory parameters in a short time, so it is difficult to capture good videos.

Therefore, in a first aspect, some exemplary embodiment of the present disclosure provide a flight control method for a movable platform with a photographing device, including: obtaining at least one of a type of a target photographing object of the photographing device or a distance between the target photographing object and the movable platform; determining a target flight trajectory among a plurality of flight trajectories based on at least one of the type of the target photographing object or the distance between the target photographing object and the movable platform; and controlling the movable platform to fly according to the target flight trajectory, and using the photographing device to photograph the target photographing object.

In a second aspect, some exemplary embodiment of the present disclosure provide another flight control method for a movable platform with a photographing device, including: obtaining a type of a target photographing object of the photographing device; and upon determining that the type of the target photographing object is a person type, controlling the movable platform to fly to a target starting point to allow the movable platform to take the target starting point as a starting point to photographing the target photographing object, where a relative positional relationship between the target starting point and the target photographing object satisfies a preset condition.

In a third aspect, some exemplary embodiment of the present disclosure provide another flight control method for a movable platform with a photographing device, including: obtaining a distance between the target photographing object and the movable platform; and upon determining that a distance between the target photographing object and the movable platform is greater than a preset threshold, when the movable platform encircles the target photographing object, controlling the movable platform to encircle the target photographing object based on an inner spiral course, where the photographing device faces the target photographing object and forms a preset angle with a nose direction of the movable platform.

### BRIEF DESCRIPTION OF THE DRAWINGS

In order to clearly illustrate the technical solutions in some exemplary embodiments of the present disclosure, the following will briefly introduce the drawings for the description of some exemplary embodiments. Obviously, the accompanying drawings in the following description are only some exemplary embodiments of the present disclosure. For a person skilled in the art, other drawings may also be obtained based on these drawings without any creative effort.

FIG. 1 is a schematic diagram of a flight control system according to some exemplary embodiments of the present disclosure;

FIG. 2 is a schematic diagram of an application scenario according to some exemplary embodiments of the present disclosure;

FIG. 3 is a schematic diagram of a frame selection target shooting object according to some exemplary embodiments of the present disclosure;

FIGS. 4, 7, 10, 16 and 24 are various flowcharts of a flight control method for a UAV according to some exemplary embodiments of the present disclosure;

FIGS. 5 and 6 are various schematic diagrams of flight trajectories according to some exemplary embodiments of the present disclosure;

FIG. 8 is a schematic diagram of a target shooting object according to some exemplary embodiments of the present disclosure;

FIG. 9 is a schematic diagram of a process of selecting a target flight trajectory according to some exemplary embodiments of the present disclosure;

FIG. 11 is a schematic diagram of the translation or rotation of a UAV and a photographing device according to some exemplary embodiments of the present disclosure;

FIGS. 12A and 12B are various schematic diagrams of a first sub-trajectory according to some exemplary embodiments of the present disclosure;

FIGS. 13A, 14A and 15A are schematic diagrams of a UAV flight direction, a field of view of an environment sensing device and a field of view of a photographing device according to some exemplary embodiments of the present disclosure;

FIGS. 13B, 14B, 14C, F14D and 15B are schematic diagrams of an actual flight trajectory of a UAV and a field of view of an environmental sensing device according to some exemplary embodiments of the present disclosure;

FIGS. 17A and 17B are schematic diagrams of a field of view of an environment sensing device of a UAV according to some exemplary embodiments of the present disclosure;

FIGS. 18, 19 and 20 are various schematic diagrams of a flight trajectory according to some exemplary embodiments of the present disclosure;

FIG. 21 is a schematic diagram of the display of a flight area according to some exemplary embodiments of the present disclosure;

FIG. 22 is a schematic diagram of the display of real-time position and flight direction of a UAV on a map according to some exemplary embodiments of the present disclosure;

FIG. 23 is a schematic diagram of current sub-trajectory and progress of a UAV according to some exemplary embodiments of the present disclosure;

FIG. 25 is a schematic diagram of a video corresponding to a sub-trajectory, a target video clip, and a sub-clip required by a video editing template according to some exemplary embodiments of the present disclosure;

FIG. 26 is a schematic diagram of a preview video according to some exemplary embodiments of the present disclosure;

FIG. 27 is a schematic diagram of selecting a target video editing template according to some exemplary embodiments of the present disclosure;

FIG. 28 is a schematic diagram of an editing process of a target video editing template according to some exemplary embodiments of the present disclosure;

FIG. 29 is a schematic diagram of an interaction between a terminal device and a UAV according to some exemplary embodiments of the present disclosure;

FIG. 30 is a schematic diagram of the structure of a flight control device according to some exemplary embodiments of the present disclosure; and

FIG. 31 is a schematic diagram of the structure of a UAV according to some exemplary embodiments of the present disclosure.

### DETAILED DESCRIPTION

The technical solutions in some exemplary embodiments of the present disclosure will be described below in conjunction with the accompanying drawings. Apparently, the described exemplary embodiments are only some of the embodiments, not all of the embodiments, of the present disclosure. Based on these exemplary embodiments, all other embodiments obtained by a person of ordinary skill in the art without making creative efforts belong to the scope of protection of this disclosure.

For the above problems in the related technologies, some exemplary embodiments of the present disclosure provides a flight control method and a video editing method of a UAV, so that during a flight process of the UAV according to a target trajectory including multiple sub-trajectories, a photographing device on the UAV may shoot in different sub-trajectories, and a terminal equipment may edit the shooting material into a video combining different shots. The flight control method of the UAV may be applied to a flight control device. The video editing method may be applied to a video editing device.

The flight control device may be a chip or integrated circuit with a data processing function. The flight control device includes, but is not limited to, for example, a central processing unit (CPU), a digital signal processor (DSP), an application specific integrated circuit (ASIC), or a field-programmable gate array (FPGA) and so on. The flight control device may be installed on a terminal device or UAV. Exemplarily, when the flight control device is installed on the terminal device, the terminal device may communicate with the UAV to control the UAV. Exemplarily, when the flight control device is installed on the UAV, the flight control device may control the UAV by executing the above method. The flight control device may be an electronic device with a data processing function, and the electronic device may include, but is not limited to, a UAV, a terminal device, or a server. Exemplarily, when the flight control device is a terminal device with a data processing function, the terminal device may communicate with the UAV to control the UAV. Exemplarily, when the flight control device is a UAV with a data processing function, the UAV may control itself by executing the above control method (the UAV herein can be any type of movable platform).

The video editing device may be installed on a terminal device or a server. The terminal device may be connected to the UAV in communication, so as to receive a video captured by the photographing device of the UAV, and transmit the video to the video editing device. For example, the video editing device may be a software product installed in the terminal device or server. The software product may include an application program for executing the video editing method provided by some exemplary embodiments of the present disclosure. For example, the video editing device may be a terminal device or a server with data processing capability.

Examples of the specific types of the communication between the terminal device and the UAV may include, but are not limited to, communication via: the Internet, Local Area Network (LAN), Wide Area Network (WAN), Bluetooth, Near Field Communication (NFC) technologies, networks based on mobile data protocols such as General Packet Radio Service (GPRS), GSM, Enhanced Data GSM Environment (EDGE), 3G, 4G or Long Term Evolution (LTE) protocols, infrared (IR) communication technologies, and/or WiFi; in addition, it may be wireless, wired, or a combination thereof.

It will be apparent to a person skilled in the art that other types of UAVs may also be used without limitation. Embodiments of the present application may be applied to various types of UAVs. For example, the UAV may be a small or large UAV. In some exemplary embodiments, the UAV may be a rotorcraft, for example, a multi-rotor UAV propelled by air with multiple propulsion devices. The embodiments of the present disclosure are not limited thereto, and the UAV may also be other types of UAVs, such as fixed-wing UAVs.

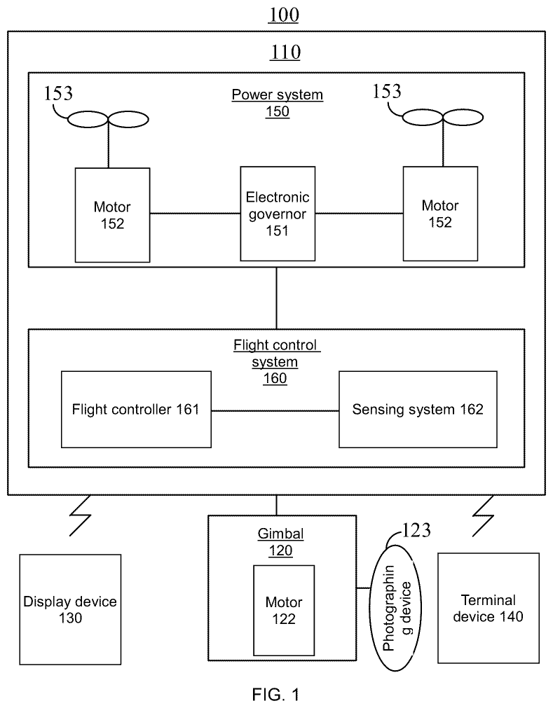

FIG. 1 is a schematic diagram of a flight control system according to some exemplary embodiments of the present disclosure. In the following exemplary embodiments, a rotor UAV will be taken as an example for illustration.

An unmanned aerial system 100 may include a UAV 110, a display device 130, and a terminal device 140. The UAV 110 may include a power system 150, a flight control system 160, a frame, and a gimbal 120 carried by the frame. The UAV 110 may communicate wirelessly with the terminal device 140 and the display device 130. The UAV 110 may be an agricultural UAV or an industrial application UAV, and there is a need for cycle operations.

The frame may include a body and a landing gear. The body may include a center frame and one or more arms connected to the center frame. The one or more arms extend radially from the center frame. The landing gear is connected to the body and is used to support the UAV 110 when it lands.

The power system 150 may include one or more electronic governors 151, one or more propellers 153, and one or more motors 152 corresponding to the one or more propellers 153. The motor 152 is connected between the electronic governor 151 and the propeller 153. The motor(s) 152 and propeller(s) 153 are arranged on the arm(s) of UAV 110. The electronic governor 151 is used to receive a driving signal generated by the flight control system 160, and provide a driving current to the motor 152 according to the driving signal, so as to control the rotation speed of the motor 152. The motor 152 is used to drive the propeller to rotate, thereby providing power for the flight of the UAV 110. This power enables the UAV 110 to achieve one or more degrees of freedom of motion. In some exemplary embodiments, the UAV 110 may rotate about one or more axes of rotation. For example, the rotation axis may include a roll axis (Roll), a yaw axis (Yaw) and a pitch axis (Pitch). It should be understood that the motor 152 may be a DC motor or an AC motor. In addition, the motor 152 may be a brushless motor or a brushed motor.

The flight control system 160 may include a flight controller 161 (which may refer to the aforementioned flight control device) and a sensing system 162. The sensing system 162 is used to measure the attitude information of the UAV. That is, position information and state information of the UAV 110 in space, such as three-dimensional position, three-dimensional angle, three-dimensional velocity, three-dimensional acceleration, and three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, and a barometer. For example, the global navigation satellite system may be a global positioning system (GPS). The flight controller 161 is used to control the flight of the UAV 110, for example, the flight of the UAV 110 may be controlled according to the attitude information measured by the sensing system 162. It should be understood that the flight controller 161 may control the UAV 110 according to pre-programmed instructions, and may also control the UAV 110 by responding to one or more remote control signals from the terminal device 140.

The gimbal 120 may include a motor 122. The gimbal is used to carry a photographing (shooting) device 123. The flight controller 161 may control the movement of the gimbal 120 via the motor 122. In some exemplary embodiments, the gimbal 120 may further include a controller for controlling the movement of the gimbal 120 by controlling the motor 122. It should be understood that the gimbal 120 may be independent of the UAV 110, or may be a part of the UAV 110. It should be understood that the motor 122 may be a DC motor or an AC motor. In addition, the motor 122 may be a brushless motor or a brushed motor. It should also be understood that the gimbal may be located on a top of the UAV or on a bottom of the UAV.

The photographing device 123 may be, for example, a camera or a video camera, etc., which are used to capture images. The photographing device 123 may communicate with the flight controller, and take photographs under the control of the flight controller. The photographing device 123 of some exemplary embodiments may include at least a photosensitive element. The photosensitive element may be, for example, a complementary metal oxide semiconductor (CMOS) sensor or a charge-coupled device (CCD) sensor. Exemplarily, the camera may capture an image or series of images with a specific image resolution. Exemplarily, the photographing device may capture a series of images at a specific capture rate. Exemplarily, the photographing device may have multiple adjustable parameters. The photographing device may capture different images with different parameters under same external conditions (e.g., location, lighting). It can be understood that the photographing device 123 may also be directly fixed on the UAV 110, so that the gimbal 120 may be omitted.

The display device 130 may be located at a ground end of the UAV 100, may communicate with the UAV 110 wirelessly, and may be used to display the attitude information of the UAV 110. In addition, an image captured by the photographing device 123 may also be displayed on the display device 130. It should be understood that the display device 130 may be an independent device, or may be integrated in the terminal device 140.

The terminal device 140 is located at the ground end of the unmanned aerial system 100 and may communicate with the UAV 110 in a wireless manner, so as to remotely control the UAV 110. It should be understood that the above naming of the various components of the unmanned aerial system is only for the purpose of identification, and should not be construed as limiting the embodiments of the present disclosure.

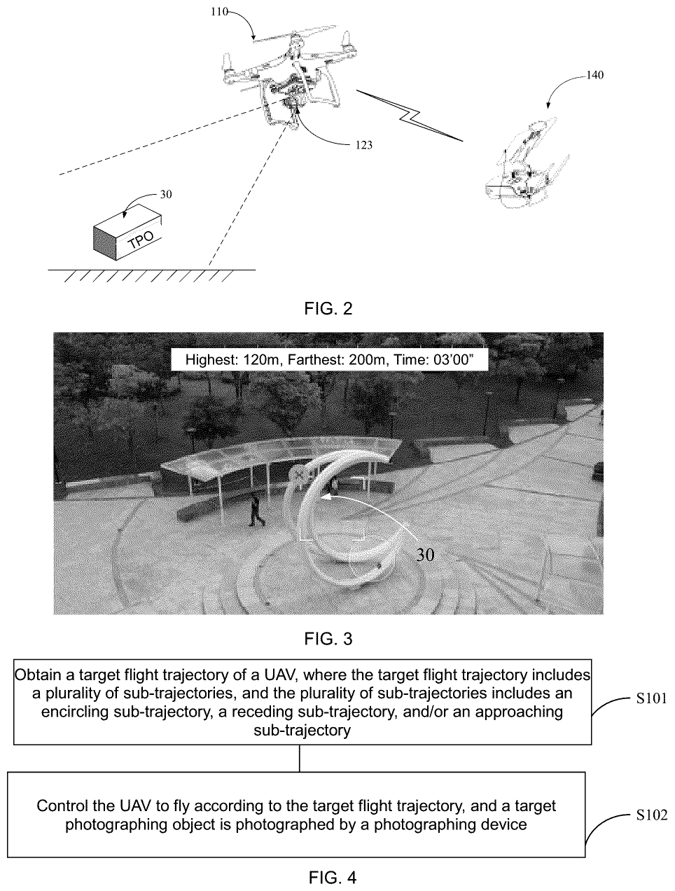

In some exemplary embodiments, the UAV flight control method provided by herein may be applied to the scenario shown in FIG. 2. When the UAV 110 is flying according to a target flight trajectory, the photographing device 123 on the UAV 110 may shoot the target object 30; in addition, the UAV 110 may communicate with the terminal device 140, so that the information about the target flight trajectory is sent to the terminal device 140; information about the target flight trajectory may be displayed by the display device in the terminal device 140. Exemplarily, the photographing device 123 may be mounted on the UAV 110 via a gimbal. Exemplarily, the target flight trajectory may be determined among various flight trajectories based on the type of the target object 30 and/or the distance between the target object 30 and the UAV 110. Exemplarily, the target flight trajectory may include a plurality of sub-trajectories, including an encircling sub-trajectory, a receding sub-trajectory, and/or an approaching sub-trajectory.

It can be understood that the present disclosure does not impose any limitation on the target photographing object (TPO), and specific settings may be made according to actual application scenarios. The target photographing object may be selected by a user. In one example, the target photographing object may carry a satellite positioning device (such as a GPS device, a Beidou satellite positioning device, etc.). The satellite positioning device may send position information of the target photographing object to the UAV or a terminal device mounted on the flight control device. In an example, the target photographing object may be selected by the user from pictures taken by the photographing device. For example, the photographing device of the UAV may transmit the pictures (images) captured in real time to the terminal device, and the display device of the terminal device (such as the display device 130 in FIG. 1) then displays the pictures. Referring to FIG. 3, the user may directly select the target photographing object 30 to be photographed in the picture. FIG. 3 shows a schematic diagram of a sculpture building in a frame selection picture as the target photographing object. Alternatively, the terminal device may perform target detection on the picture (image) (for example, detect the type of the target, etc.), and display the detected target. The user may click one of the targets to select a target photographing object to be photographed among a plurality of detected targets. In an example, the flight control device may acquire pre-recorded information about the target photographing object, for example, the target subject is a portrait. The information of the target photographing object may be face information. The flight control device may determine the target photographing object from the pictures captured by the photographing device according to the information of the target photographing object.

In some exemplary embodiments, the target photographing object may be a stationary object or a moving object.

A stationary object may remain substantially stationary in the environment. Examples of stationary targets may include, but are not limited to: landscape features (e.g., trees, plants, mountains, hills, rivers, streams, creeks, valleys, boulders, rocks, etc.) or man-made features (e.g., structures, buildings, roads, bridges, poles, fences, immobile vehicles, signs, lights, etc.). Stationary targets may include large or small targets. Users can select stationary targets. Stationary targets may be identified. Optionally, stationary targets may be mapped. In some cases, a stationary object may correspond to a selected portion of a structure or object. For example, a stationary object may correspond to a specific section (e.g., top floor) of a skyscraper.

A moving object may be able to move in the environment. A moving object may be in motion all the time, or may be in motion in some portions of a period of time. A moving object may move in a relatively stable direction or may change its direction. A moving object may move in the air, on land, underground, on or in water, and/or in space. A moving object may be a living moving object (e.g., a person, an animal) or an inanimate moving object (e.g., a moving vehicle, a moving device, an object carried by an object of life). The moving object may include a single moving object or a group of moving objects. For example, the moving object may include a single person or a group of moving people. The moving target can be large or small. A user may select a moving object. The moving object may be identified. The trajectory may be changed or updated as the moving object moves.

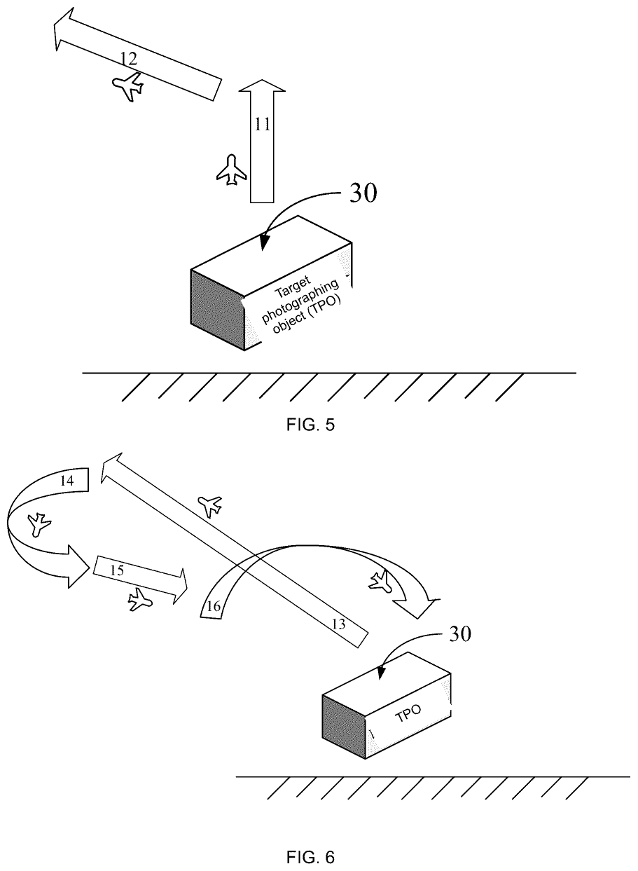

Next, the flight control method of the UAV according to some exemplary embodiments of this disclosure will be described. Please refer to FIG. 4, which is a schematic flow chart of a first flight control method provided by some exemplary embodiments of this disclosure. The method may be performed by a flight control device. The following takes the flight control device being mounted on the UAV as an example for illustration; the method includes:

Step S101, obtaining a target flight trajectory of a UAV, where the target flight trajectory includes a plurality of sub-trajectories. The plurality of sub-trajectories includes an encircling sub-trajectory, a receding sub-trajectory, and/or an approaching sub-trajectory.

Step S102, controlling the UAV to fly according to the target flight trajectory, and a target photographing object is photographed by a photographing device.

The plurality of sub-trajectories included in the target flight trajectory is configured to: enable the UAV to fly in a variety of different flight modes, so as to photograph the target photographing object in different ways.

In some exemplary embodiments, the target flight trajectory includes a plurality of sub-trajectories, and the plurality of sub-trajectories includes trajectory types such as an encircling sub-trajectory, a receding sub-trajectory, and/or an approaching sub-trajectory, where the encircling sub-trajectory refers to that the UAV flies around the target photographing object; the receding sub-trajectory refers to that the UAV flies in a direction away from the target photographing object; and the approaching sub-trajectory refers to that the UAV flies in a direction toward the target photographing object.

Each sub-trajectory in the plurality of sub-trajectories includes at least one of the following trajectory parameters: flight parameters of the UAV and the photographing parameters of the photographing device. The trajectory parameters of the plurality of sub-trajectories are different from each other. Exemplarily, the flight parameters of the UAV may include, but are not limited to, the position, speed, acceleration, altitude, flight distance or flight direction of the UAV. The photographing parameters of the photographing device may include, but are not limited to, focal length, zoom factor, and exposure parameters, etc. In the case where the photographing device is mounted on the UAV via a gimbal, the photographing parameters of the photographing device may further include a rotation parameter(s) of the gimbal (which affects the field of view direction of the photographing device). For example, gimbal orientation, rotation speed, rotation acceleration or rotation direction, etc. Since each sub-trajectory includes its trajectory parameters, this enables the UAV and/or the photographing device to automatically perform tasks according to the trajectory parameters without user operation, which is beneficial to save user steps and improve user experience.

Exemplarily, in a specific implementation process, each sub-trajectory may be parameterized to obtain the trajectory parameters of each sub-trajectory. For example, the sub-trajectory of an oblique fly type mainly focuses on the angle between the trajectory and a horizontal plane and the distance between the sub-trajectory and a starting point; an arc-circling sub-trajectory focus on the angle and radius of the circle. With the set generation parameters, high-order Bezier curves may be used to generate various sub-trajectory polynomials. That is, a time-related polynomial is used to describe each sub-trajectory, and then a trajectory sampling tool is used to sample the trajectory to obtain several trajectory points of the sub-trajectory. Each trajectory point corresponds to a trajectory parameter(s). During the flight of the UAV according to the sub-trajectories, for example, the position(s) of the trajectory point(s) obtained in advance may be used. According to the current state of the UAV (position, speed/velocity, acceleration) (speed is a scalar quantity that refers to “how fast an object is moving”; whereas velocity is a vector quantity that refers to “the rate at which an object changes its position.” Herein weather speed or velocity is referred to should be determined based on the specific situations), the speed and acceleration that the UAV should have when it is close to the trajectory point may be calculated in real-time, and then the speed and acceleration at the time point may be sent to the flight control device of the UAV to complete the automatic control of the flight process of the UAV.

Exemplarily, considering that when the UAV is flying according to the target flight trajectory, there may be a need for speed control, such as acceleration in this stage, deceleration in this stage, and so on. As mentioned above, a time-related polynomial may be used to describe each sub-trajectory, and then a trajectory sampling tool may be used to sample the trajectory, next the velocity attribute may be set for the trajectory point by taking advantage of the characteristics of trajectory polynomial sampling by time. The set speed control requirements may be used to calculate the speed corresponding to each trajectory point in real time. In addition, during a UAV flight process, the position of the trajectory point that is currently being followed may be determined in real time, and the velocity corresponding to the trajectory point may be obtained, thereby realizing the control of the flight velocity/speed of each sub-trajectory.

Exemplarily, for the control of the orientation of the photographing device, during the UAV flight, the positional relationship between the target photographing object and the UAV may be calculated in real time, and the orientation of the photographing device (or the orientation of the gimbal) may be controlled according to the positional relationship.

In some exemplary embodiments, for at least two sub-trajectories of the same trajectory type, the at least two different sub-trajectories may be obtained by setting different trajectory parameters (such as different flight parameters or photographing parameters). For example, the flight direction of the UAV or the orientation of the photographing device in the at least two sub-trajectories of encircling sub-trajectory type may be different.

Exemplarily, the plurality of sub-trajectories included in the target flight trajectory may be sub-trajectories belonging to the same type or sub-trajectories belonging to different types, where the trajectory parameters of the plurality of sub-trajectories are different.

In an example, please refer to FIG. 5, the target flight trajectory includes two sub-trajectories, which belong to the same type, namely a receding sub-trajectory 11 and a receding sub-trajectory 12, in which the direction of the arrow indicates the flight direction of the UAV. It can be seen from FIG. 5 that although they all belong to the same receding sub-trajectory type, the trajectory parameters of the receding sub-trajectory 11 and the receding sub-trajectory 12 may be different. For example, their flight directions of the UAV as shown in FIG. 5 are different. In addition, the photographing parameters of the photographing device in the receding sub-trajectory 11 and the receding sub-trajectory 12 may also be different. For example, the focal length may be different, and the orientation of the photographing device may be different.

In another example, please refer to FIG. 6, the target flight trajectory includes 4 sub-trajectories, belonging to different types, which are respectively a receding sub-trajectory 13, an encircling sub-trajectory 14, an approaching sub-trajectory 15, and an encircling sub-trajectory 16, where the direction of the arrow indicates the flight direction of the UAV. Although the encircling sub-trajectory 14 and the encircling sub-trajectory 16 both belong to the encircling sub-trajectory type, their trajectory parameters may be different. For example, in FIG. 6, the flight directions of the UAV may be different. In addition, the photographing parameters of the photographing device in the encircling sub-trajectory 14 and the encircling sub-trajectory 15 may also be different, such as different focal lengths.

After obtaining the target flight trajectory including a plurality of sub-trajectories, the flight control device may control the UAV to fly according to the target flight trajectory, and use the photographing device to photograph a target photography object. Thus, it realizes that only one flight process is required to obtain multiple video frames corresponding to multiple sub-trajectories, so as to obtain video frames combining multiple trajectories. Further, the UAV may automatically fly according to each sub-trajectory in the target flight trajectory, without frequent automatic adjustment by the user, which reduces the operation steps of the user and is beneficial to improve user experience.

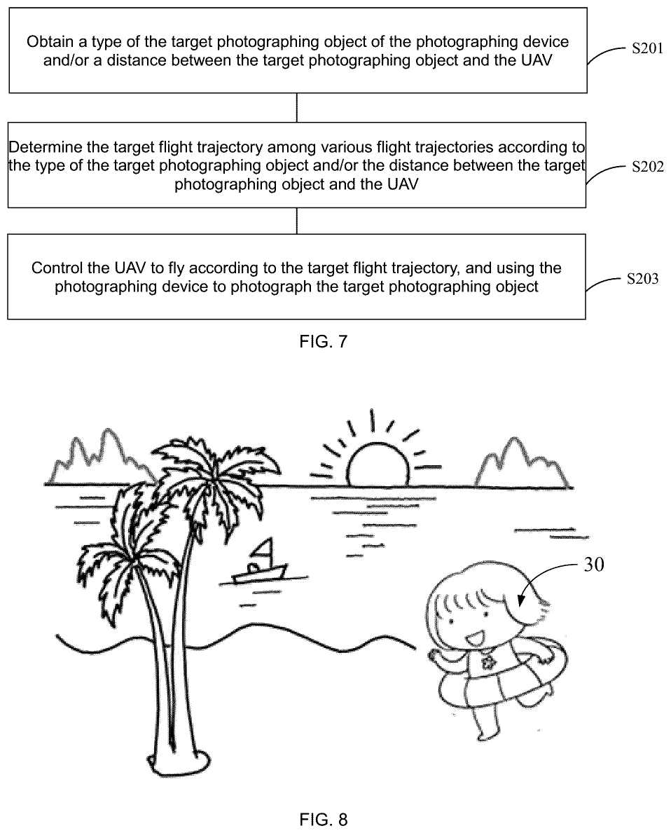

In some exemplary embodiments, the target flight trajectory may be selected from various preset flight trajectories, for example, the target flight trajectory may be selected by the user from various flight trajectories; or it may be that the flight control device selects the target flight trajectory based on the relevant information of the target photographing target. For example, please refer to FIG. 7, its shows a second schematic flow chart of the flight control method, the method includes:

Step S201, obtaining a type of the target photographing object of the photographing device and/or a distance between the target photographing object and the UAV.

Step S202, determining the target flight trajectory among various flight trajectories according to the type of the target photographing object and/or the distance between the target photographing object and the UAV.

Step S203, controlling the UAV to fly according to the target flight trajectory, and using the photographing device to photograph the target photographing object.

In some exemplary embodiments, taking into account the actual characteristics of the target photographing object, based on the identification on the type of the target photographing object and/or the distance between the target photographing object and the UAV, a flight trajectory suitable for the target photographing object may be determined among a variety of flight trajectories as the target flight trajectory. Therefore, it is ensured that the UAV has a better photographing effect on the target photographing object while flying according to the target flight trajectory.

In some exemplary embodiments, taking into account the fact that the distance between the target photographing object and the UAV is related to the imaging size of the target photographing object in the photographing frame. In the case where the focal length of the photographing device is constant, the greater the distance between the target photographing object and the UAV, the smaller the imaging size of the target photographing object in the photographing frame. Conversely, the smaller the distance between the target photographing object and the UAV, the larger the imaging size of the target photographing object in the photographing frame. Alternatively, according to at least one of the type of the target photographing object and the imaging size of the target photographing object in the photographing frame, a flight suitable for the target photographing object can be determined among various flight trajectories as the target flight trajectory. In this way, a better photographing effect for the target photographing object may be ensured.

In some exemplary embodiments, the type of the target photographing object may include at least an attribute type and/or a scene type. The attribute type of the target photographing object is configured to describe the characteristics of the target photographing object. For example, the attribute type of the target photography object may be a person type, a building type, a landscape type, or an animal type. The scene type is configured to describe the characteristics of a scene where the target photographing object is located. For example, the scene type of the target photographing object may be a city type, a seaside type, or a mountain type. In an example, please refer to FIG. 8, the attribute type of the target photographing object 30 is a person type, and the scene type is a seaside type. Exemplarily, the flight control device may determine a flight trajectory suitable for the target photographing object among various flight trajectories as the target flight trajectory according to at least one of the attribute type or the scene type of the target photographing object. In this way, a better photographing effect for the target photographing object may be ensured. Certainly, the type of the target photographing object may also include other types, and is not limited to the at least one of the attribute type or the scene type mentioned herein.

To identify the type of the target photographing object, exemplarily, the type of the target photographing object may be selected by the user (such as at least one of an attribute type or a scene type). Exemplarily, in the case where the target photographing object carries a satellite positioning device, the type of the target photographing object may be determined according to the position information obtained by the satellite positioning device; for example, identifying the type of the target photographing object with reference to the location information and the map for the location information. For example, identifying the type of the target photographing object (e.g., identifying the scene type of the target photographing object) with reference to the location information and a picture (image) containing the target photographing object. Exemplarily, in the picture containing the target photographing object, the type of the target photographing object may be determined by a preset target identification method; for example, it is determined whether the target photographing object is a portrait type through face recognition, and if a face is detected, it is determined that the target photographing object is a portrait type.

Regarding the distance between the target photographing object and the UAV, it is first necessary to determine the position of the target photographing object, and then determine the distance between the target photographing object and the UAV based on the position of the target photographing object and the position of the UAV. Exemplarily, the target photographing object may carry a satellite positioning device, and the satellite positioning device may send the position information of the target photographing object to the UAV or a terminal device with a flight control device. Certainly, the target photographing object may also carry other positioning devices, such as a device using the UWB technology for positioning, which is not limited herein. Exemplarily, the coordinates of the target photographing object may also be input by the user using the terminal device, or the coordinates of the target photographing object may be determined according to the position selected by the user in an image containing the target photographing object. Exemplarily, the UAV may also be controlled to fly to the location of the target photographing object (for example, to fly above the target photographing object), and then the current location of the UAV is the location of the target photographing object.

Further, considering that the traditional target recognition estimates the actual spatial coordinates of the target object based on the position of the target photographing object in the image, in such a way, although an approximate distance between the target photographing object and the UAV may be obtained, there are the following problems when using this distance to calculate the coordinates of the target: an accurate distance cannot be obtained for a target photographing object whose specific type is not identified, because although the coordinates of the target photographing object may be obtained by the above method, the accuracy of the coordinates is unreliable. The control of the UAV flight trajectory depends on the coordinates of the target photographing object, so unreliable coordinates may not lead to an accurate flight trajectory. Therefore, when the UAV determines the position of the target photographing object, it may calculate the coordinates of the target photographing object through the process of moving thereof relative to the target. For example, multiple images taken from different directions may be obtained through the process of moving relative to the target, then the coordinates of the target photographing object may be calculated based on the multiple images taken from different directions to obtain more reliable coordinates, and then the distance between the target photographing object and the UAV may be obtained based on the coordinate.

In addition, during the follow-up process of the UAV flying according to the target flight trajectory, considering that there may be a situation in which the photographing device does not face the target photographing object for the multiple sub-trajectories included in the target flight trajectory, in such a case, the target photographing object followed by the photographing device may be lost in the image, and the target photographing object cannot be located by image recognition. Therefore, when the target photographing object is lost from the image, the reliable coordinates of the target photographing object obtained by the above relative motion process may be used as the trajectory point to continue to perform subsequent control, so as to ensure the reliable operation of UAV or photography device.

In some exemplary embodiments, after obtaining the type of the target photographing object of the photographing device and/or the distance between the target photographing object and the UAV, the flight control device may determine the target flight trajectory, among various flight trajectories, based on whether the type of the target photographing object is a specified type and/or a result from comparing the distance between the target photographing object and the UAV with a preset distance threshold. The specified type herein may be set according to the actual application scenario. For example, the specified type may include at least one of an attribute type (such as a person type, an animal type, a natural landscape type, a building type, or a vehicle type, etc.) or a scene type (such as a city type, a seaside type or a mountain type, etc.). Exemplarily, taking the person type as an example, the flight control device may select from various flight trajectories according to whether the type of the target photographing object is a person type and/or a difference between the distance between the target photographing object and the UAV and a preset distance threshold. A flight trajectory suitable for photographing a person(s) may be determined as the target flight trajectory.

In some exemplary embodiments, various flight trajectories may be preset for different types of target photographing objects and/or different distances between the target photographing object and the UAV, and different flight trajectory strategies may be employed for different types and/or different distances of target photographing object. Each of the plurality of flight trajectories includes a plurality of sub-trajectories. The trajectory parameters of the plurality of sub-trajectories included in each flight trajectory may be different.

Exemplarily, the plurality of sub-trajectories included in each flight trajectory may be selected from the trajectory set; the trajectory set may include a plurality of sub-trajectories. The plurality of sub-trajectories may be divided into three types of trajectories, which are a encircling sub-trajectory, a receding sub-trajectory, and/or an approaching sub-trajectory. The trajectory parameters of the plurality of sub-trajectories may be different from one another. The combinations of the sub-trajectories corresponding to each of the various flight trajectories may also be different. For example, the trajectory set may be {receding sub-trajectory 11, receding sub-trajectory 12, encircling sub-trajectory 21, encircling sub-trajectory 22, approaching sub-trajectory 31, approaching sub-trajectory 32}. There may be 2 preset flight trajectories; the combination of the sub-trajectories in the first flight trajectory is: receding sub-trajectory 11→approaching sub-trajectory 32→encircling sub-trajectory 22, and the combination of the sub-trajectories in the second flight trajectory is: receding sub-trajectory 12→encircling sub-trajectory 21→approaching sub-trajectory 31→encircling sub-trajectory 22.

The various flight trajectories or the set of trajectories may be stored in the flight control device, or may be stored in a server, and the flight control device obtains them from the server.

It can be understood that the flight trajectory may be preset before delivery to the user; it may also be a flight trajectory obtained by selecting at least two sub-trajectories from the trajectory set according to the user's own needs during actual application. Further, parameters such as the order, distance, and angle of at least two sub-trajectories in the flight trajectory may also be edited, so that a new set of flight trajectory may be designed, which may be uploaded to the server to share with other users.

Some sub-trajectories in the trajectory set may be preset before delivery to the user. Alternatively, the user may manually control the UAV to fly a certain trajectory according to actual needs during an actual application process, and the flight control device records the flight parameters of the UAV during the flight (such as speed/velocity, distance from the target photographing object, movement mode, etc.) and the photographing parameters of the photographing device (such as the focal length and orientation of the photographing device, etc.), and other trajectory information, and then generates a sub-trajectory that can be stored in the trajectory set according to the recorded trajectory information, so that the user may use it later or upload it to the server to share with other users.

In some exemplary embodiments, for different types of target photographing object and/or different distances between the target photographing object and the UAV, taking the target photographing object as a person type or non-person type as an example, the flight control device may determine, based on whether the target photographing object is a person type and/or a difference between the distance between the target photographing object and the UAV and a preset distance threshold, a flight trajectory suitable for photographing a person among various flight trajectories as the target flight trajectory, where the various flight trajectories may include at least one of a first flight trajectory corresponding to a portrait mode, a second flight trajectory corresponding to a normal mode, and a third flight trajectory corresponding to a long-distance mode.

A person skilled in the art may understand that other kinds of flight trajectories may also be included, for example, a flight mode corresponding for at least one of other attribute types or scene types of the target photographing object than the portrait type, for example, flight trajectories for natural landscape types (attribute types), flight trajectories for city types (scene types) or flight trajectories for seaside types (scene types), etc., which is not limited herein. For a flight trajectory for a city type, when setting the flight trajectory, it is necessary to consider the obstacles in the city to determine the accurate flying range, for example, referring to a city map to determine the flying range to reduce the risk of hitting obstacles. For a flight trajectory of the seaside type (scene type), it may be considered to fly at a lower altitude when flying on one side of the sea (for example, the distance from the sea level is lower than a preset value). This is not limited herein.

Exemplarily, if the type of the target photographing object is a person type, the first flight trajectory may be selected from various flight trajectories as the target flight trajectory; if the type of the target photographing object is a non-person type, the second flight trajectory may be selected from various flight trajectories as the target flight trajectory, so as to realize determining the target flight trajectory suitable for the target photographing object. In this way, a better photographing effect for the target photographing object may be obtained.

Exemplarily, if the distance between the target photographing object and the UAV is greater than the preset distance threshold, the third flight trajectory may be selected from various flight trajectories as the target flight trajectory; if the distance between the target photographing object and the UAV is not greater than the preset distance threshold, the second flight trajectory may be selected from various flight trajectories as the target flight trajectory, so as to realize determining the target flight trajectory suitable for the target photographing object. In this way, a better photographing effect for the target photographing object may be obtained.

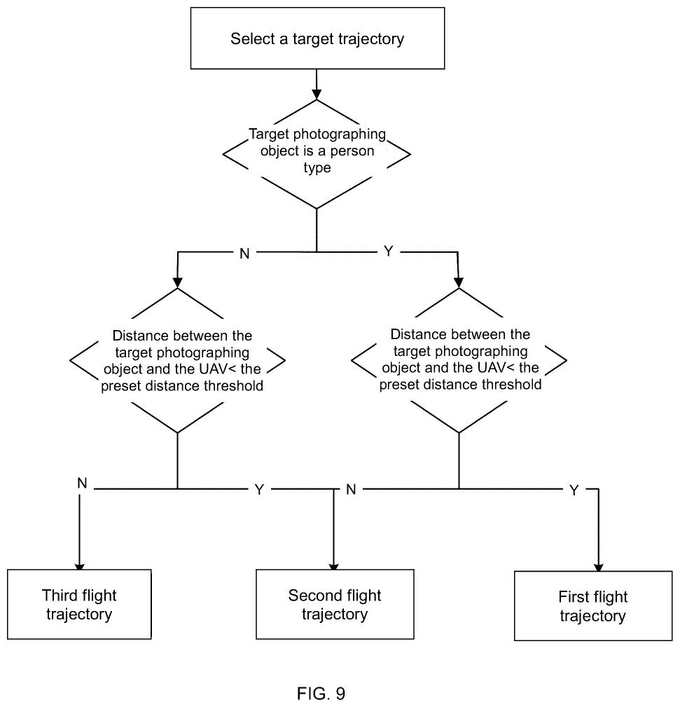

Exemplarily, referring to FIG. 9, when the flight control device selects the target trajectory, if the type of the target photographing object is a person type, and the distance between the target photographing object and the UAV is less than the preset distance threshold, the target flight trajectory is the first flight trajectory; if the type of the target photographing object is a person type, and the distance between the target photographing object and the UAV is greater than or equal to the preset distance threshold, the target flight trajectory is the second flight trajectory; if the type of the target photographing object is not a person type, and the distance between the target photographing object and the UAV is less than the preset distance threshold, then the target flight trajectory is the second flight trajectory; if the type of the target photographing object is not a person type, and the distance between the target photographing object and the UAV is greater than or equal to the preset distance threshold, the target flight trajectory is the third flight trajectory. According to some exemplary embodiments, based on the type and distance of the target photographing object (the distance between the target photographing object and the UAV), the target flight trajectory suitable for the target photographing object may be determined. In this way, a better photographing effect for the target photographing object may be ensured.

In some exemplary embodiments, the size of the flight area corresponding to each of the various flight trajectories may be different, for example, at least one of the flight height, the farthest flight distance, or the fan angle of the encircling flight may be different. For example, the flight range indication of the first flight trajectory may be: the farthest distance between the sub-trajectory and the starting point is 50 m, the height is 40 m, and the fan angle is 60°; the flight range indication of the second flight trajectory may be: the farthest distance between the sub-trajactory and the starting point is 100 m, the height is 80 m, and the fan angle is 60°; the flight range indication of the third flight trajectory may be: the farthest distance between the sub-trajectory and the starting point is 100 m, the height is 100 m, and the fan angle is 60°. Exemplarily, taking the rectangular area of length*width*height as an example, the sizes of the flight rectangular areas corresponding to the various flight trajectories may be different. For example, the flight area of the first flight trajectory is an area of 50 m*50 m*40 m, the second flight area is an area of 100 m*80 m*80 m, and the third flight area is an area of 100 m*80 m*100 m.

The size of the flight area corresponding to each flight trajectory among the various flight trajectories may be different, and the flight distance of each of the flight trajectories may also be different. This makes the flight time corresponding to each flight trajectory among the various flight trajectories also different.

Exemplarily, the farthest flight distance may be automatically matched according to the size of the target photographing object in the image, so that the UAV may present the target photographing object in of different sizes in the image shown on the camera screen with the same ratio.

Exemplarily, it is possible to take pictures while recording a video or take pictures between sub-trajectories, and take a plurality of pictures of different scenes and different angles of view of the target at a preset position.

Exemplarily, the flight area and speed of the target flight trajectory may be controlled according to the size of the target photographing object in the image. Alternatively, the flight area and speed of the target flight trajectory may be controlled according to the distance between the target photographing object and the UAV.

In some exemplary embodiments, in order to reduce useless flight process, when the UAV is flying according to the target flight trajectory, the photographing device is performing tasks related to photographing the target photographing object during the entire flight process. This is beneficial to improve the flight efficiency of the UAV and avoid the power consumption problem caused by useless flight (that is, the UAV does not perform any tasks during the flight).

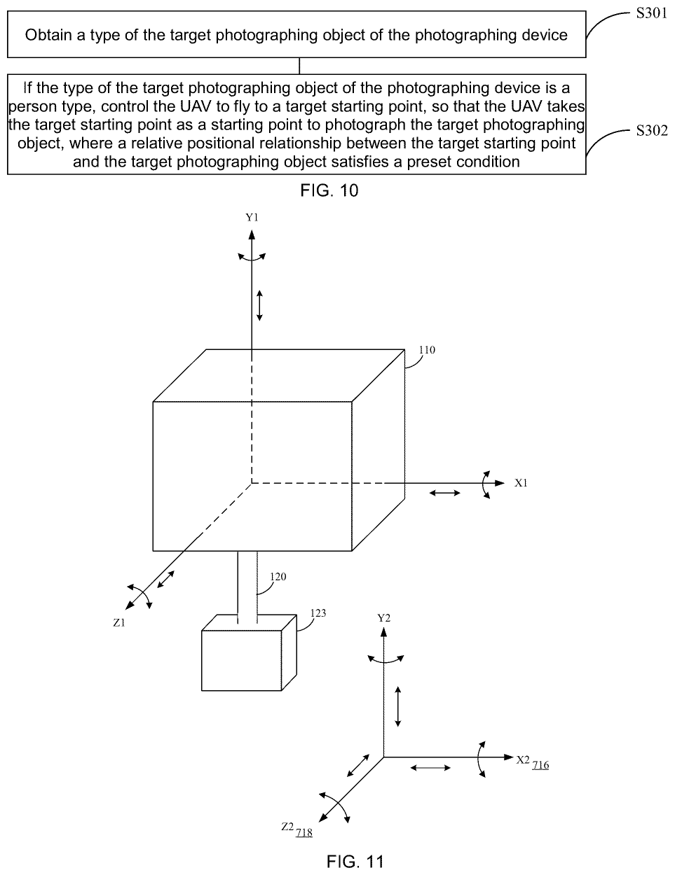

Considering that the UAV is flying according to the flight trajectory, in the related art, the UAV's photographing device is controlled to take pictures by taking the current location of the UAV as the starting point of the flight trajectory. However, when the first flight trajectory corresponding to the portrait mode is used as the target flight trajectory, the distance between the current location of the UAV and the target photographing object is too far. It may cause poor imaging problems. For example, the position of the target photographing object in the image may be improper or the size thereof may be too small. In view of the foregoing, referring to FIG. 10, some exemplary embodiments of the present disclosure provides a third schematic flow chart of the flight control method, the method includes:

Step S301, obtaining a type of the target photographing object of the photographing device.

Step S302, if the type of the target photographing object of the photographing device is a person type, controlling the UAV to fly to a target starting point, so that the UAV takes the target starting point as a starting point to photograph the target photographing object, where a relative positional relationship between the target starting point and the target photographing object satisfies a preset condition.

According to some exemplary embodiments, in the case of portrait shooting, considering the relative positional relationship between the UAV and the target photographing object, if the relative positional relationship between the starting point of the UAV and the target photographing object does not meet the preset condition, the UAV may be controlled to fly to a target starting point that satisfies the preset condition, so that the UAV takes the target starting point as the starting point to photograph the target photographing object, Thus, based on the relative positional relationship between the UAV and the target object, the starting point of the UAV for photographing the portrait may be adjusted, so that the portrait has a better imaging effect in the video frame.

The preset condition herein may be configured as follows: when the photographing device shoots the target photographing object at the target starting point, the target photographing object at least is at a preset position in the shooting frame or occupies a preset size. The preset position and the preset size may be specifically set according to the actual application scene, which is not limited herein. For example, the preset position is in the middle of the image, and the preset size is greater than or equal to 20% of the image size. In some exemplary embodiments, by changing the starting point of the UAV to ensure that the target photographing object has an appropriate position or an appropriate size in the image, the target photographing object can be clearly shown in the image, which makes the portrait have a better imaging effect in the video frames.

The preset condition herein may include at least one of the following: the height difference between the target starting point and the target object is a preset height; or the horizontal distance between the target starting point and the target object is a preset horizontal distance. The preset height and the preset horizontal distance may be determined according to the user's expected position or size of the person in the image, so that the obtained portrait meets the actual needs of the user.

In some exemplary embodiments, if the type of the target photographing object of the photographing device is a person type and the relative positional relationship between the current starting point of the UAV and the target photographing object does not satisfy the preset condition, the flight control device may control the UAV to fly to the target starting point that meets the preset condition, so as to ensure that the portrait has a better imaging effect in the video frames.

In some exemplary embodiments, after the UAV arrives at the target starting point, the control device may control the UAV to fly from the target starting point according to the target flight trajectory, and use the photographing device to photograph the target photographing object. A person skilled in the art can understand that the process of adjusting the starting point of the UAV to the target starting point conforming to the preset condition is not limited to be applied to the first flight trajectory corresponding to the portrait mode, it may also be applied to other scenes where the UAV performs portrait photographing.

In exemplary embodiments, the UAV is capable of free motion in the environment with respect to six degrees of freedom (e.g., three translational degrees of freedom and three rotational degrees of freedom). Exemplarily, the flight process of the UAV may be constrained with respect to one or more degrees of freedom, for example, constrained by a preset path, track, or orientation.

The photographing device may be mounted on the UAV via a gimbal, and at least one of the motion of the gimbal and the motion of the UAV may drive the photographing device to make free motion relative to six degrees of freedom (for example, three translational degrees of freedom and three rotational degrees of freedom). Exemplarily, in the case where the photographing device is fixed on the UAV, the movement of the UAV may drive the photographing to make free motion relative to six degrees of freedom (for example, three translational degrees of freedom and three rotational degrees of freedom).

For the various flight trajectories provided by the present disclosure, each flight trajectory includes multiple sub-trajectories. The UAV and/or the photographing device may move with respect to different degrees of freedom in the plurality of sub-trajectories.

For an example, as shown in FIG. 11, which illustrates the process of performing exemplary adjustments to the orientation, position, posture, and/or one or more movement features of the UAV 110, the gimbal 120, and/or the photographing device 123. The UAV 110 may rotate about up to three orthogonal axes, e.g., an X1 (pitch) axis, a Y1 (yaw) axis, and a Z1 (roll) axis. The rotations about the three axes are referred to herein as pitch rotation, yaw rotation and roll rotation, respectively. The angles of rotation around the three axes may be referred to as pitch angle, yaw angle, and roll angle, respectively. Exemplarily, as shown in FIG. 11, the UAV 110 may perform a translational movement along the X1, Y1 and Z1 axes or a rotational movement around the X1, Y1 and Z1 axes, respectively.

As shown in FIG. 11, the photographing device 123 may move around and/or along three orthogonal axes, for example, an X2 (pitch) axis, a Y2 (yaw) axis and a Z2 (roll) axis. The X2, Y2 and Z2 axes are parallel to the X1, Y1 and Z1 axes respectively. In some exemplary embodiments, for example, the photographing device 123 may be rotated about up to three orthogonal axes X2, Y2 and Z2 by rotation of the gimbal 120 and/or the UAV 110. The rotations about the three axes are referred to herein as pitch rotation, yaw rotation and roll rotation, respectively. The angles of rotation around the three axes may be referred to as pitch angle, yaw angle, and roll angle, respectively. In some exemplary embodiments, the motion of the gimbal 120 and/or the UAV 110 may cause the photographing device 123 to perform translational motions along the X2, Y2, and Z2 axes or rotational motions around the X2, Y2, and Z2 axes, respectively.

In some exemplary embodiments, the movement of the photographing device 123 may be limited to the movement relative to the UAV 110 about and/or along the three axes X2, Y2 and Z2. For example, the photographing device 123 is rotatable (for example, the gimbal 120 may drive the photographing device 123 to rotate relative to the UAV 110). In some exemplary embodiments, the photographing device 123 may be limited to rotate about one of the X2, Y2, and Z2 axes. For example, the photographing device 123 may be only rotatable around the Y2 axis, or the photographing device 123 may be limited to only rotate around two of the X2, Y2 and Z2 axes. Alternatively, the photographing device 123 may be rotatable about all three of the X2, Y2 and Z2 axes. In some exemplary embodiments, the photographing device 123 is limited to move only along one of the X2, Y2, and Z2 axes. For example, the movement of the photography device 123 is limited to the movement along the X2 axis. For example, the photographing device 123 is limited to move along only two of the X2, Y2 and Z2 axes. For example, the photographing device 123 may move along all three of the X2, Y2 and Z2 axes. In some exemplary embodiments, the photographing device 123 is capable of performing rotational and translational motion relative to the UAV 110. For example, the photographing device 123 is capable of rotating and/or translating along or around one, two or three of the X2, Y2 and Z2 axes.

In some exemplary embodiments, the attitude, orientation and/or position of the photographing device 123 may be adjusted by the UAV 110 and/or the gimbal 120. For example, a 60° rotation of the photographing device 123 about a given axis (e.g., yaw axis) may be achieved by: the gimbal 120 rotating 60° around a given axis relative to the UAV 110 to drive the photographing device 123 to rotate 60°, or the UAV 110 itself rotates 40° around a given axis and the gimbal 120 itself rotates 20° around a given axis, so the combination of rotation drives the photographing device to rotate 60°. In some exemplary embodiments, it may be realized by adjusting the photographing of the photographing device 123, for example, adjusting the zoom factor, focal length or exposure parameters of the photographing device 123, and the like.

Next, the multiple sub-trajectories according to some exemplary embodiments of the present disclosure will be described. The trajectory parameters of the multiple sub-trajectories are different. For example, the flight direction of the UAV in the multiple sub-trajectories may be different, or the flight speed may be different, or the orientation of the photographing device may be different, and so on.

In some exemplary embodiments, the multiple sub-trajectories may include a first sub-trajectory, and the first sub-trajectory is an approaching sub-trajectory. The first sub-trajectory indicates that the UAV is flying towards the target photographing object. The field of view of the photographing device may be controlled to rotate from a direction where the target photographing object cannot be photographed to a direction facing the target photographing object so as to realize the display effect of the target photographing object appears in the photographing image. During the flight of the UAV according to the first sub-trajectory, the orientation of the field of view of the photographing device may be adjusted, for example, controlling the pitch angle of the photographing device to rotate from a first pitch angle to a second pitch angle; when the pitch angle of the photographing device is at the first pitch angle, the target photographing object is outside the photographing frame of the photographing device; when the pitch angle of the photographing device is at a second pitch angle, the target photographing object is within the photographing frame of the photographing device. In this way, the display effect of the target photographing object in the photographing frame can be realized.

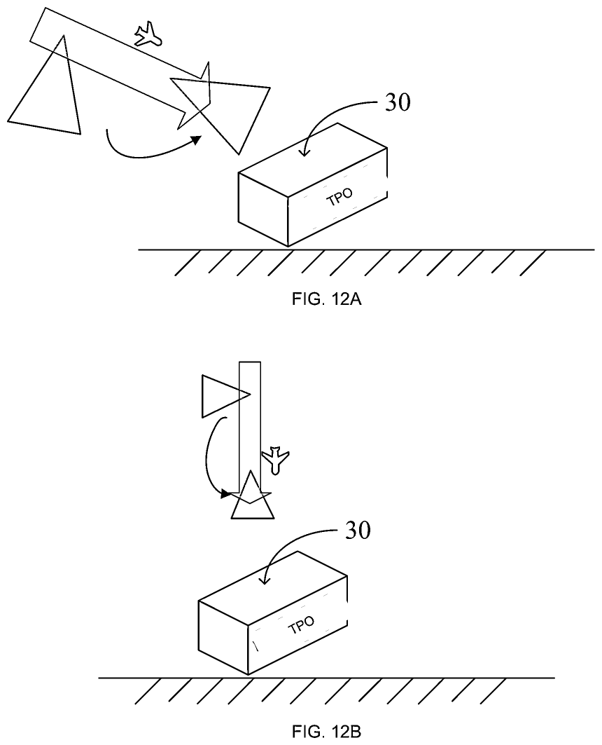

For example, referring to FIG. 12A and FIG. 12B, FIG. 12A and FIG. 12B are schematic diagrams of two kinds of first sub-trajectories. The direction of the thick arrow is the moving direction of the first sub-trajectory. It can be seen that the moving directions of the UAV in the two first sub-trajectories are different. The base of the isosceles triangle represents the field of view direction of the photographing device, and the arc pointing to the two isosceles triangles represents the rotation process of the direction of the photographing device.

In FIG. 12A, the first pitch angle of the photographing device is a certain angle (for example, 90°) downward relative to the horizontal plane. For example, the photographing device can be rotated by means of rotating the gimbal. In such a case, the field of view of the photographing device faces downward, and the target photographing object cannot be photographed in the field of view of the photographing device. During the flight of the UAV towards the target photographing object according to the first sub-trajectory, the flight control device controls the photography device to lift up according to a preset speed, and rotate from the first pitch angle to the second pitch angle, so that the direction of the field of view of the photographing device is gradually turned from downward to towards the target photographing object. In this way, the target photographing object gradually appears in the photographing frame.

In FIG. 12B, the first pitch angle of the photographing device is rotated upward to form a certain angle (such as 0°) relative to the horizontal plane. For example, the photographing device may be rotated by means of rotating the gimbal. FIG. 12B shows the field of view direction of the photographing device. In such a case, the target photographing object cannot be photographed in the field of view of the photographing device. During the flight of the UAV towards the target photographing object according to the first sub-trajectory, the flight control device controls the photographing device to rotate downward according to a preset speed, from the first pitch angle to the second pitch angle, so that the field of view of the photographing device gradually faces the target photographing object. In this way, the target photographing object gradually appears in the photographing frame.

The rotation speed of the photographing device is proportional to the flight distance of the UAV in the first sub-trajectory. In the case where the rotation angle of the photographing device is fixed, the longer the flight distance of the UAV in the first sub-trajectory, the greater the rotation speed of the photographing device.

Exemplarily, the multiple sub-trajectories may include other approaching sub-trajectories. For example, there is a sub-trajectory indicating that the UAV is flying towards the target photographing object, and the field of view of the photographing device is always towards the direction of the target photographing object, in order to realize the effect of shooting the target photography object from far to near.

In some exemplary embodiments, the multiple sub-trajectories may include a second sub-trajectory, and the second sub-trajectory is a receding sub-trajectory or an approaching sub-trajectory. Taking the receding sub-trajectory as an example, the second sub-trajectory indicates that during the flight of the UAV vertically upward away from the target photographing object, the photographing device faces vertically downward to keep the photographing target object in the photographing frame all the time. During the flight of the UAV according to the second sub-trajectory, for example, the photographing device may be controlled to face vertically downward, so as to keep the photographing target object always in the photographing frame. Further, it is also possible to control the UAV to rotate the yaw angle while controlling the photographing device to face vertically downward, so as to keep the photographing target object always at the center of the photographing frame.

Exemplarily, in order to realize that the target photographing object is always in the center of the photographing frame, the UAV and photographing device can be directed towards the target photographing object under the control of the flight controls; however, when the UAV is controlled to fly according to the second sub-trajectory, that is, during the process of ascending at a certain speed and rotating by the yaw angle, the photographing device (such as rotating the yaw angle by the gimbal) may need to rotate the pitch angle by more than 90° in order to shoot the target photographing object. Since most of the gimbal's pitch angle rotation range cannot exceed 90°, there is a limit problem. Therefore, the UAV must rotate the yaw angle to make the gimbal within the controllable rotation range of the pitch angle to ensure that the target photographing object at in the center of the frame. In this case, the control for the photographing device (or gimbal) and the control of the UAV are coupled. In view of this situation, the present disclosure realizes that during the flight of the UAV according to the second sub-trajectory, the photographing device no longer follows the target photographing object, but vertically downwards, that is, it is fixedly rotated downward by a certain angle (such as 90°) relative to the horizontal plane, while the UAV rotates the yaw angle during ascent, after the photographing device is facing down vertically, there is no need to control the photographing device (or gimbal), and it is only necessary to control the yaw angle of the UAV in order to realize decoupling the control of the photographing device (or gimbal) and that of the UAV.

Exemplarily, the multiple sub-trajectories may include other receding sub-trajectories. For example, there is a sub-trajectory indicating that the UAV flies away from the target photographing object obliquely upward while flying away from the target photographing object. However, the field of view of the photographing device always faces the target photographing object.

In some exemplary embodiments, the multiple sub-trajectories may include a third sub-trajectory, and the third sub-trajectory indicates the UAV to fly in a direction toward the target photographing object or to fly in a direction away from the target photographing object. The photographing device photographs the target photographing object from different angles. For example, during the flight of the UAV according to the third sub-trajectory, the UAV may be controlled to fly in a direction toward the target photographing object or in a direction away from the target photographing object, and the rolling angle of the photographing device is also controlled so that the photographing device may photograph the target photographing object from different angles.

Taking the UAV flying in a direction toward the target photographing object as an example, the roll angle of the photographing device (or gimbal) is fixedly rotated clockwise to the limit of the maximum controllable roll axis. During the flight of the UAV according to the third sub-trajectory, the roll angle of the photographing device may be controlled to rotate counterclockwise to the limit of the maximum controllable roll axis, so that the target photographing object may be photographed from different angles.

The speed of the roll angle rotation of the photographing device may be positively correlated with the flight distance of the third sub-trajectory. In the case where the roll angle of the photographing device may change within a fixed angle range, the longer the flight distance of the third sub-trajectory is, the faster the roll angle of the photographing device rotates.

In some exemplary embodiments, the multiple sub-trajectories may include a fourth sub-trajectory, and the fourth sub-trajectory indicates that the UAV flies in a direction towards the target photographing object or flies in a direction away from the target photographing object; in addition, the focal length of the photographing device is changed during the flight of the UAV to reflect the effect of scene changes brought about by different focal lengths. For example, during the flight of the UAV according to the fourth sub-trajectory, the UAV may be controlled to fly in a direction toward the target photographing object, and changing the focal length of the photographing device from the longest focal length to the widest focal length so as to achieve a wider range of scene; or during the flight of the UAV according to the fourth sub-trajectory, the UAV may be controlled to fly in a direction away from the target photographing object, and the focal length of the photographing device changes from the widest focal length to the longest focal length. For example, an optical zoom and digital zoom of the photographing device are controlled to reach the longest focal length, so as to realize accurate positioning of the target photographing object in a large-scale scene. The completion ratio of the zoom stroke during the zooming process of the photographing device is positively correlated with the flight distance of the fourth sub-trajectory.

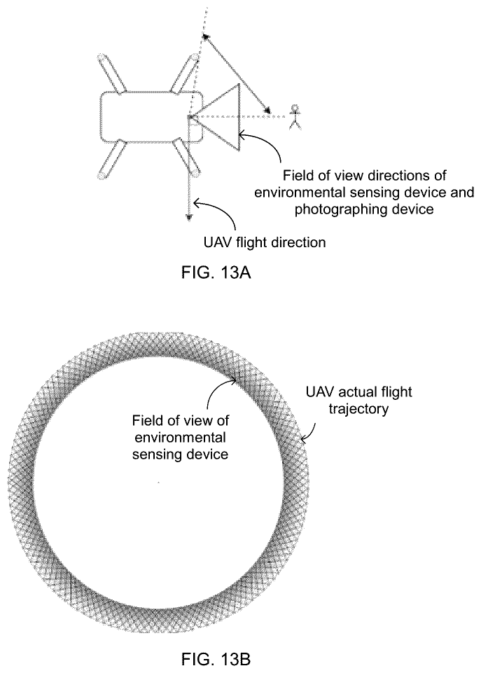

In some exemplary embodiments, the multiple sub-trajectories also include an encircling sub-trajectory. UAVs are usually equipped with environmental sensing devices on their nose and/or tail. A UAV can avoid obstacles according to the environmental information detected by the environmental sensing device. However, in the scenario where the UAV flies around the target photographing object based on an encircling sub-trajectory, due to the limited sensing field of view of the environment sensing device, the flight direction of the UAV may be on a side of the UAV body, which makes the environmental sensing device installed on the nose unable to sense the environmental information about the UAV flight trajectory, thus making it impossible to avoid obstacles. In one example, see FIG. 13A, taking the environmental sensing device installed on the nose of the UAV as an example, the direction of the field of view of the environmental sensing device is consistent with the direction of the nose of the UAV, as shown in FIG. 13A; the field of view direction of the environmental sensing device and the field of view direction of the photographing device both point to the target photographing object, as shown in FIG. 13B. The sub-trajectory is an encircling trajectory, as shown in FIG. 13A. The flight direction of the UAV does not intersect the field of view of the environmental sensing device. If the UAV flies around the target photographing object in an encircling trajectory, as shown in FIG. 13B, the actual flight trajectory of the UAV is not within the sensing field of view of the environmental sensing device. In this case, the environments; sensing device cannot sense the environmental information along the flight direction of the UAV, and obstacle avoidance cannot be achieved.

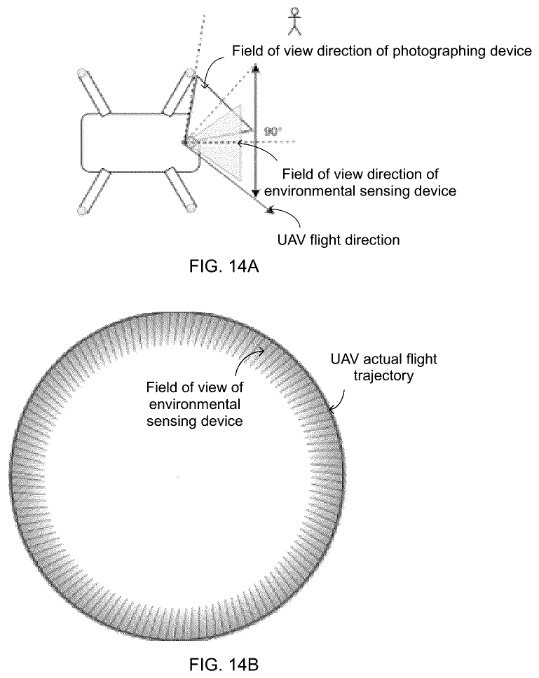

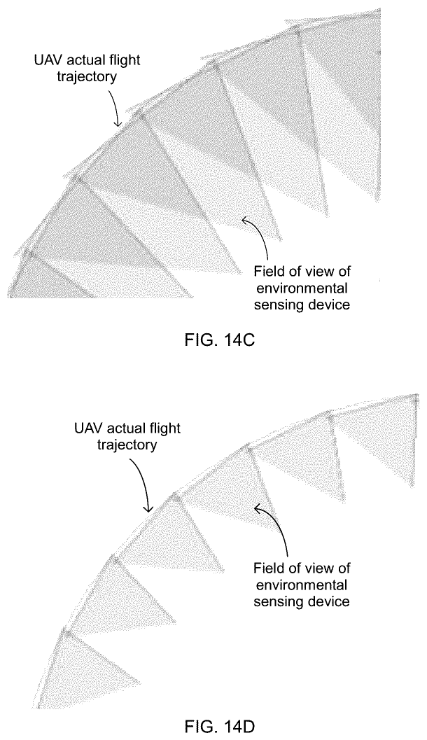

However, it has been found in the present disclosure that when the encircling radius is smaller than a certain threshold, the relative orientation of the field of view of the environmental sensing device and the field of view of the photographing device may be adjusted so that the actual flight trajectory of the UAV is within the sensing field of view of the environmental sensing device. Referring to FIG. 14A, the photographing device faces the target photographing object and is in a preset angle with the direction of the nose of the UAV (the direction of the field of view of the environmental sensing device is consistent with the direction of the nose of the UAV), when the UAV flies around the target photographing object in the encircling trajectory, the actual flight trajectory of the UAV is within the sensing field of view of the environmental sensing device. As shown in FIGS. 14B and 14C, in this case, the environmental sensing device may sense the environmental information along the flight direction of the UAV, such that obstacle avoidance can be achieved.

However, in the case where the encircling radius is greater than a certain threshold, as shown in FIG. 14D, even if the relative orientation of the field of view of the environmental sensing device and the field of view of the photographing device may be adjusted, the actual flight trajectory of the UAV still cannot be within the sensing field of view of the environmental sensing device. The reason is that the photographing device is usually mounted on the gimbal, and the gimbal is set to a limited position so that the UAV does not appear in the pictures taken by the photographing device, examples are UAV landing gear or propellers. Thus, the adjustment of the orientation of the photographing device is limited. In some cases, it is impossible to adjust the relative orientation of the field of view of the environmental sensing device and the field of view of the photographing device to make the actual flight trajectory of the UAV within the sensing field of view of the environmental sensing device.

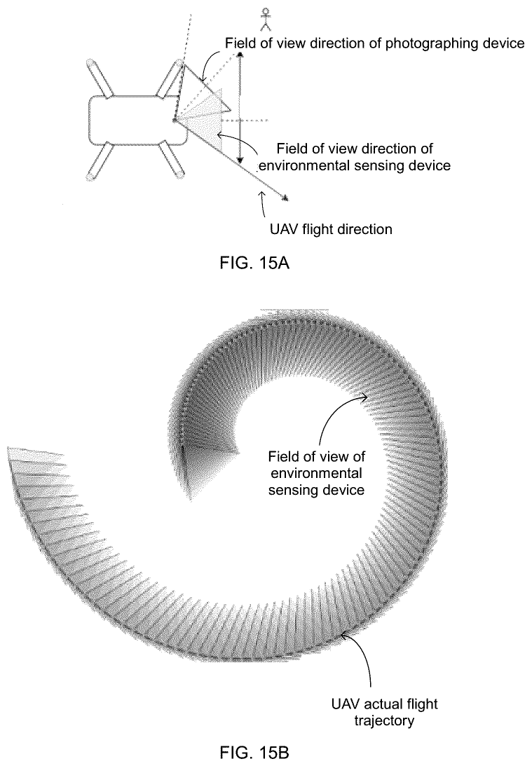

Please refer to FIG. 15A, the photographing device faces the target photographing object and is at a preset angle with the direction of the nose of the UAV (the direction of the field of view of the environmental sensing device is consistent with the direction of the nose of the UAV), when the UAV flies around the target photographing object in an inner spiral route (as shown in FIG. 15B), since the circle radius of the inner spiral route gradually shrinks, the actual flight trajectory of the UAV may be within the sensing field of view of the environmental sensing device. In this case, the environmental sensing device may sense the environmental information along the flight direction of the UAV, so it can realize obstacle avoidance.

Thus, in some exemplary embodiments, the multiple sub-trajectories include a fifth sub-trajectory, and the fifth sub-trajectory is an encircling sub-trajectory. The fifth sub-trajectory indicates the UAV to fly around the target photographing object based on an inner spiral route, and the photographing device shoots towards the target photographing object. For example, during the flight of the UAV according to the fifth sub-trajectory, the UAV may be controlled to encircle the target photographing object based on the inner spiral route; the photographing device faces the target photographing object and forms a preset angle with the direction of the nose of the UAV (the orientation of the field of view of the environmental sensing device is consistent with the direction of the nose of the UAV).

Therefore, in some exemplary embodiments, the multiple sub-trajectories include a fifth sub-trajectory, and the fifth sub-trajectory is also an encircling sub-trajectory. The fifth sub-trajectory indicates that when the distance between the target photographing object and the UAV is greater than a preset threshold, the UAV flies around the target photographing object based on an inner spiral route, and the photographing device shoots towards the target photographing object. In addition, the multiple sub-trajectories also include a sixth sub-trajectory, and the sixth sub-trajectory is also an encircling sub-trajectory. The sixth sub-trajectory indicates that when the distance between the target photographing object and the UAV is less than or equal to the preset threshold, the UAV flies around the target photographing object based on a circular route, and the photographing device shoots towards the target photographing object.

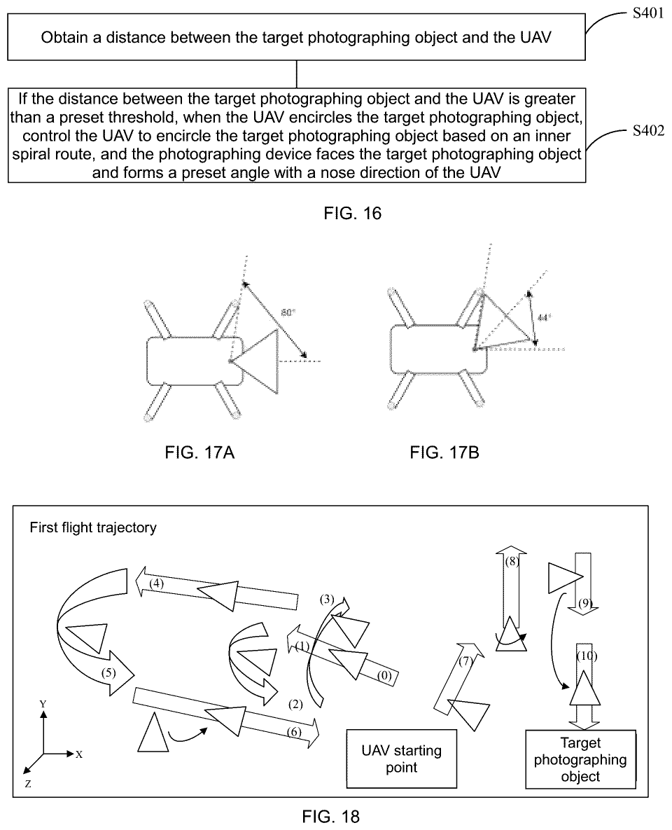

For the encircling sub-trajectory, please refer to FIG. 16, the present disclosure provides a fourth schematic flow chart of the flight control method. During the flight of the UAV around the target photographing object, it may fly on a spiral route to avoid obstacles, and the method includes:

Step S401, obtaining a distance between the target photographing object and the UAV.

Step S402, if the distance between the target photographing object and the UAV is greater than a preset threshold, when the UAV encircles the target photographing object, controlling the UAV to encircle the target photographing object based on an inner spiral route, and the photographing device faces the target photographing object and forms a preset angle with a nose direction of the UAV.

The photographing device is mounted on the UAV via the gimbal, and the gimbal has a rotation limit. The setting of the preset threshold is related to the rotation limit. In one example, the environmental sensing device is installed on the nose of the UAV. The field of view of the environmental sensing device is oriented in the same direction as the nose of the UAV. The angle between the photographing device and the direction of the nose of the UAV is determined based on the field of view of the photographing device. For example, please refer to FIG. 17A and FIG. 17B, assuming that the field of view (FOV) of the photographing device is 70° *55°. As shown in FIG. 17A, the angle between the landing gear and the nose is 80° (with the gimbal roll axis as the center). In order to exclude the landing gear and leave a margin of 1°, the maximum angle between the photographing device and the nose is 80°−1°−70°/2=44°. Based on geometric calculation, it can be concluded that the preset distance is about 63 meters to 65 meters, for example, 64.8 meters.

In some exemplary embodiments, the distance between the target photographing object and the UAV is not greater than a preset threshold, when the UAV encircles the target photographing object, the UAV may be controlled to encircle the target photographing object based on a circular route.

Exemplarily, the environmental sensing device includes, but is not limited to, a binocular vision sensor or a monocular vision sensor.

As an example, it is assumed that the distance from the UAV to the target photographing object has a radius of 100 meters and that the UAV's environmental sensing device is located at a fixed location (for example, on the front side). the photographing device is directed toward the target photographing object, and the target photographing object is located at an angular offset (for example, 44°) from the environmental sensing device. For example, the photographing device and the environmental sensing device are angularly offset (for example, 44°). An inner spiral route may be used to ensure avoidance of obstacles within the field of view (e.g., within the field of view of the environmental sensing device), but the encircling radius is gradually reduced (e.g., by losing about 8% of the radius per 30° rotation, for example, for every encircling the target photography object by a 30-degree arc, the radius loss is 100 m*(1−0.9182)=8.18 m). When the distance between the UAV and the target photographing object is not greater than the preset threshold (such as when the radius of the UAV and the target photographing object is less than or equal to 64.8 m), by using the circular route, obstacles can be avoided according to the historical environmental information obtained by the environmental sensing device without employing the inner spiral flight trajectory. In some exemplary embodiments, the environmental sensing device of the UAV nose is used for lateral obstacle avoidance, and the effect of obstacle avoidance of the UAV with only the environmental sensing device in the forward direction when flying on the lateral trajectory may be achieved, which improves flight safety and reduces requirements on aircraft hardware.

Exemplarily, the inner spiral route includes, but is not limited to, an Archimedes (constant velocity) spiral, a Cartesian (constant angle) spiral, or a Fibonacci (golden) spiral.

In some exemplary embodiments, the above-mentioned first flight trajectory corresponding to the portrait mode, the second flight trajectory corresponding to the normal mode, and the third flight trajectory corresponding to the long-distance mode, which may be combined to form the above-mentioned sub-trajectories.

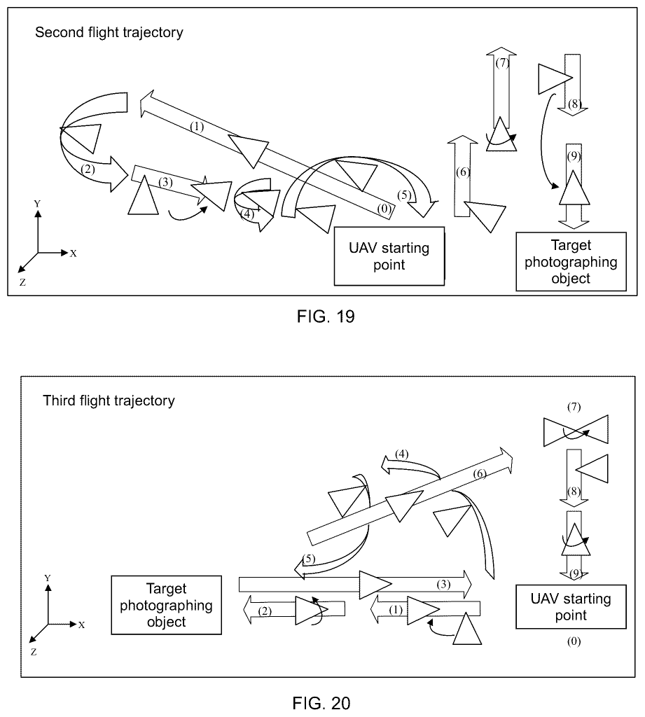

In an example, FIG. 18, FIG. 19 and FIG. 20 respectively show schematic diagrams of the first flight trajectory corresponding to the portrait mode, the second flight trajectory corresponding to the normal mode, and the third flight trajectory corresponding to the long-distance mode. The first flight trajectory, the second flight trajectory and the third flight trajectory all include approaching sub-trajectories, encircling sub-trajectories and receding sub-trajectories. (0), (1), (2) . . . Indicate the flight sequence of various sub-trajectories. The direction of the arrow indicates the flight direction of the UAV. The bottom edge of the triangle represents the field of view direction of the photographing device, and the rotation arrow represents changing the field of view direction of the photographing device.

As shown in FIG. 18, FIG. 19 and FIG. 20, the sub-trajectory (6) and sub-trajectory (9) in the first flight trajectory, the sub-trajectory (3) and the sub-trajectory (8) in the second flight trajectory, the sub-trajectory (1) and sub-trajectory (8) in the third flight trajectory form the first sub-trajectory; the sub-trajectory (8) in the first flight trajectory, the sub-trajectory (7) in the second flight trajectory, and the sub-trajectory (9) in the third flight trajectory form the second sub-trajectory; the sub-trajectory (2) in the third flight trajectory forms the third sub-trajectory; the sub-trajectory (3) in the third flight trajectory forms the fourth sub-trajectory; the sub-trajectory (2), the sub-trajectory (3) and sub-trajectory (5) in the first flight trajectory, the sub-trajectory (2), the sub-trajectory (4) and the sub-trajectories (5) in the second flight trajectory, the sub-sub-trajectory (4) and sub-trajectory (5) in the third flight trajectory form the fifth sub-trajectory. In some cases it can also be a circular arc trajectory. The sizes of the flight areas corresponding to the first flight trajectory, the second flight trajectory and the third flight trajectory may be different. Exemplarily, for the fifth sub-trajectory, the focal length of the photography device may be changed. For example, for the sub-trajectory (5) in the first flight trajectory, the focal length of the photographing device may be adjusted to 2 times of the widest focal length. Exemplarily, for the fifth sub-trajectory, if the distance between the UAV and the target photographing object exceeds the preset distance when the fifth trajectory is followed for flying, the zoom factor of the photographing device may be increased.

In one example, for the second flight trajectory, it may include: (1) a sub-trajectory receding from a starting point; (2) a sub-trajectory of long distance encircling; (3) a sub-trajectory of approaching to discover; (4) a sub-trajectory of approaching in a counterclockwise spiral (medium); (5) a sub-trajectory of approaching in a clockwise spiral (medium-near or near); (6) a sub-trajectory of soaring from low-altitude; (7) a sub-trajectory of shooting in top view while rotating; (8) a sub-trajectory of shooting in front view while descending; (9) a sub-trajectory of shooting in top view while descending.

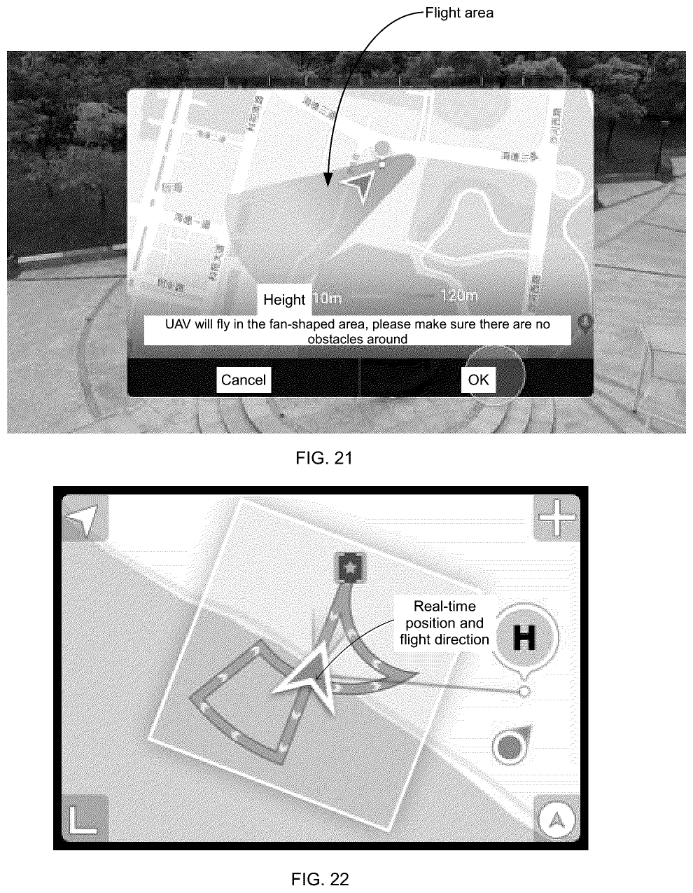

In some exemplary embodiments, after obtaining the target flight trajectory, the flight control device may send the target flight trajectory to the terminal device, so that the display device of the terminal device superimposes and displays the target flight trajectory, the flight area corresponding to the target flight trajectory, and the map corresponding to the target flight trajectory. The display device may also display trajectory parameters of multiple sub-trajectories included in the target flight trajectory. The flight area displayed on the display device may be a 2D area or a 3D area. For example, FIG. 21 shows a schematic diagram of the flight area displayed in 2D, and the flight area is displayed as being superimposed on the map.

After displaying the target flight trajectory on the display device, the user may operate the target flight trajectory on the terminal device according to actual needs. The terminal device generates trajectory adjustment information based on the user's operation on the terminal device and sends it to the flight control device, and then the flight control device may adjust the target flight trajectory according to the trajectory adjustment information. For example, the flight trajectory adjustment information may include flight area adjustment information, and the operation may include adjusting the size of the flight area displayed by the display device. For example, the flight trajectory adjustment information includes flight speed adjustment information; the operation includes adjusting the UAV flight speed corresponding to at least one sub-trajectory in the target flight trajectory.

During the flight of the UAV according to the target flight trajectory, the flight control device may send the real-time position and flight direction of the UAV to the terminal device, as shown in FIG. 22. The display device of the terminal device superimposes and displays the real-time position and flight direction on the map corresponding to the target flight trajectory, so as to let the user understand the current flight situation of the UAV.

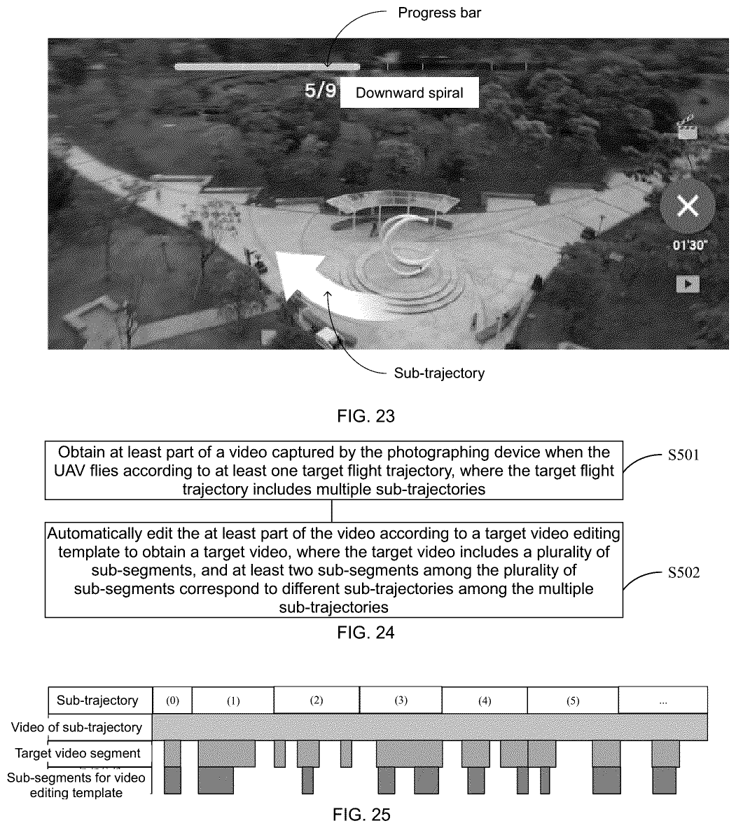

In some exemplary embodiments, considering that the target flight trajectory includes multiple sub-trajectories, in order to allow users to understand the current UAV flight situation in real time, the display device of the terminal device may display the sub-trajectory corresponding to the real-time position among the various trajectories. As shown in FIG. 23, the display device displays the sub-trajectory currently performed by the UAV (schematic diagram of spiral descending) and the current flight progress of the UAV. The UAV needs to fly 9 sub-trajectories in total, and is currently flying according to the fifth sub-trajectory (spiral descending). In some exemplary embodiments, the target flight trajectory includes multiple sub-trajectories. The display device of the terminal device is further configured to display the sub-trajectory corresponding to the real-time position among the multiple trajectories.

In some exemplary embodiments, in order to let the users know the current flight situation of the UAV in real time, the display device of the terminal device may also display the remaining flight time of the UAV flying according to the target flight trajectory.

In some exemplary embodiments, during the flight of the UAV according to the target flight trajectory, if the user selects to pause or stop the flight due to UAV obstacle avoidance, the UAV may hover in the same place, waiting for the user's follow-up instruction operation. Exemplarily, if the user still has no operation beyond a preset time, the flight control device may control the UAV to return automatically. Exemplarily, if the user selects to continue shooting, the UAV may skip the unfinished part of the current sub-trajectory and fly directly to the beginning of the next sub-trajectory for shooting.

In some exemplary embodiments, during the flight of the UAV according to the target flight trajectory, if an obstacle is detected, the UAV may be controlled to avoid the obstacle through a first detour trajectory or a second detour trajectory; both the starting point and the ending point of the first detour trajectory are within the sub-trajectory where the UAV is currently located, and the starting point of the second detour trajectory is within the sub-trajectory where the UAV is currently located, and the ending point of the second detour trajectory is within the sub-trajectory succeeding the sub-trajectory where the UAV is currently located. It is considered that if the UAV encounters an obstacle in the first half of the current sub-trajectory, after the detour, there is a high possibility that it is still within the indicated flight range of the current sub-trajectory. Therefore it is also possible to continue with the task related to the current sub-trajectory. Thus, in the event that the UAV encounters an obstacle in the first half of the sub-trajectory, a first detour trajectory may be selected to avoid the obstacle. If the UAV encounters an obstacle in the second half of the current sub-trajectory, after the detour, it may have flown out of the indicated flight range of the current sub-trajectory, and it is difficult to continue the task related to the current sub-trajectory. Therefore, in the case where the UAV encounters an obstacle in the second half of the sub-trajectory, the second detour trajectory may be selected to avoid the obstacle.

In some exemplary embodiments, the distance between the UAV and the target photographing object may be determined during the flight of the UAV in each sub-trajectory. When the distance is greater than a preset distance threshold, the focal length of the photographing device may be adjusted. For example, the optical or digital zoom of the photographing device may be adjusted to 2 times the widest focal length. In this way, images closer to the target photographing object may be captured.

During the flight of the UAV according to the target flight trajectory, the photographing device performs a photographing task related to the target photographing object, thereby shooting multiple segments of video corresponding to multiple sub-trajectories in the target flight trajectory. For the multi-segment video, please refer to FIG. 24. Some exemplary embodiments of the present disclosure provide a video editing method. The video editing method may be executed by a video editing device. The video editing device may be installed on the terminal device. The terminal device is in communication with the UAV, and the method includes:

Step S501, obtaining at least part of a video captured by the photographing device when the UAV flies according to at least one target flight trajectory, where the target flight trajectory includes multiple sub-trajectories.

Step S502, automatically editing the at least part of the video according to a target video editing template to obtain a target video, where the target video includes a plurality of sub-segments, and at least two sub-segments among the plurality of sub-segments correspond to different sub-trajectories among the multiple sub-trajectories.

In some exemplary embodiments, in the case where the UAV is flying according to the target flight trajectory including multiple sub-trajectories and the photographing device is sued to shoot the target photography object, multiple sub-segments corresponding to the multiple sub-trajectories (that is, at least part of the video) may be obtained; in addition, the target video editing template may be used to automatically edit the at least part of the video to obtain the target video, so as to obtain a video combining multiple shots. It does not require the user to manually combine and edit, reduces the user's operation steps, and is conducive to improving the user experience.

The video editing device may acquire at least part of the video captured by the photography device when the UAV is flying according to a target flight trajectory. It is also possible to acquire at least part of the video captured by the photography device for each target flight trajectory after the UAV flies along multiple target flight trajectories. Exemplarily, the target photographing objects corresponding to the multiple target flight trajectories may be the same or different, and the present disclosure does not impose any limitation on this.

In one example, the UAV may obtain a corresponding target flight trajectory for each target photographing object based on multiple target photographing objects, and use the photographing device to shoot the target photographing objects corresponding to the target flight trajectories. After shooting the multiple target photographing objects, the video editing device may obtain at least part of the video captured by the photographing device when the UAV is flying according to each target flight trajectory. The target photographing objects corresponding to the target flight trajectories are different from one another. The video editing device automatically edits the at least part of the video according to the target video editing template to obtain a target video, and the obtained target video may include the multiple target photographing objects to achieve the effect of multi-target filming.

In some exemplary embodiments, during the flight of the UAV according to the target flight trajectory, the photographing device shoots the target photographing object. In the process of shooting the video by the photographing device, the UAV may transmit the video corresponding to each sub-trajectory and the associated identification information to the video editing device in real time. The identification information is used to indicate the sub-trajectory corresponding to the video.

When the UAV is flying according to each sub-trajectory among the multiple sub-trajectories, the photographing device or UAV may need to be adjusted to the current sub-trajectory at the beginning of the sub-trajectory, or at the end of the sub-trajectory the photographing device or UAV may need to be adjusted for the next sub-trajectory. In such a case, at the beginning or end of the sub-trajectory, the video captured by the photographing device may not be desirable due to the adjustment process, resulting in unsmooth connection between various sub-trajectories. Therefore, after the video editing device receives the real-time data sent by the UAV when flying according to the target flight trajectory, a video segment corresponding to the beginning or the end of at least one sub-trajectory among the multiple sub-trajectories may be removed to obtain the at least part of the video, so as to ensure that the final target video is clear and smooth. As an example, the video editing device may remove video segments corresponding to the beginning or end of each sub-trajectory of the multiple sub-trajectories to obtain target video segments corresponding to the sub-trajectories, and then obtain the at least part of the video based on the target video segments respectively corresponding to the multiple sub-trajectories.

Since the real-time image transmission process may be disturbed by many factors, the quality of the real-time image transmission data received by the video editing device may not be desirable. That is, what the video editing device receives is a low-definition original video.

In some exemplary embodiments, in order to allow sufficient differences between scenes, angles of view, and motion trajectories of the sub-segments in the obtained target video, in the editing process, no matter which video editing template is used, the entire video corresponding to the sub-trajectory may not be used. Therefore, for the video corresponding to each sub-trajectory, the sub-segments required by different video editing templates may be summed to obtain the target video segment corresponding to each sub-trajectory. After receiving the real-time image transmission data sent by the UAV when flying according to the target flight trajectory, the video editing device may remove video segments other than the target video segments corresponding to the sub-trajectories to obtain the at least part video. In an example, FIG. 25 shows a schematic diagram of the videos corresponding to each sub-trajectory, the target video segments corresponding to each sub-trajectory, and the sub-segments needed by the video editing template.

In some exemplary embodiments, the UAV may store the videos corresponding to each sub-trajectory and the associated identification information in the process of shooting video by the photographing device. The identification information is used to indicate the sub-trajectory corresponding to the video. The identification information is stored in association with the video. In some exemplary embodiments, the UAV may store videos and identification information locally on the UAV. Additionally and/or alternatively, the UAV may also store captured videos and identification information on an external storage medium (e.g., SD card) provided on the UAV. The resolution of the videos corresponding to each sub-trajectory stored on the UAV is higher than the resolution of the videos corresponding to each sub-trajectory transmitted to the video editing device in real time. That is, the videos corresponding to the sub-trajectories stored on the UAV is a high-definition video.

Therefore, after the UAV completes its flight according to the target flight trajectory, the video editing device may receive the high-definition image transmission data sent by the UAV after flying according to the target flight trajectory, so as to obtain the at least part of the video. As an example, the extra bandwidth that has been freed from video transmission may be used to download high-definition data for post-processing and video editing.

Since the high-definition image transmission data does not need to be transmitted in real time, there is enough time to remove useless or invalid segments from the videos corresponding to the sub-trajectories captured by the photographing device. That is, the video segment corresponding to the beginning or end of at least one sub-trajectory of the multiple sub-trajectories is removed from the at least part of the video (or the high-definition image transmission data) received by the video editing device. Alternatively, video segments other than the target video segments corresponding to the sub-trajectories are removed from the at least part of the video. The target video segments corresponding to the sub-trajectories are the sum of the needed sub-segments of different video editing templates. In some exemplary embodiments, the video editing device only receives the at least part of the video that are useful, which reduces the amount of video data to be received, thereby improving reception efficiency. At the same time, the occupation of storage space can also be reduced. In some exemplary embodiments, the video editing device may first use the target editing template to edit the at least part of the video corresponding to the low-definition original video to obtain a low-definition target video; after acquiring at least part of the video corresponding to the high-definition image transmission data, the target editing template may be used to automatically edit the at least part of the video corresponding to the high-definition video transmission data to obtain a high-definition target video.

In one example, FIG. 25 shows the videos corresponding to each sub-trajectory, the target video segments corresponding to each sub-trajectory, and the sub-segments required by the video editing template. When the video editing device downloads the high-definition image transmission data, it only needs to download the target video segments corresponding to each sub-trajectory, without downloading the entire video corresponding to each sub-trajectory. Furthermore, considering that the target video editing template has been determined for the above-mentioned low-definition original video, when downloading the high-definition image transmission data corresponding to the low-definition original video, only the sub-segments required by the target video editing template may be downloaded, thereby further reducing the amount of data to be downloaded.

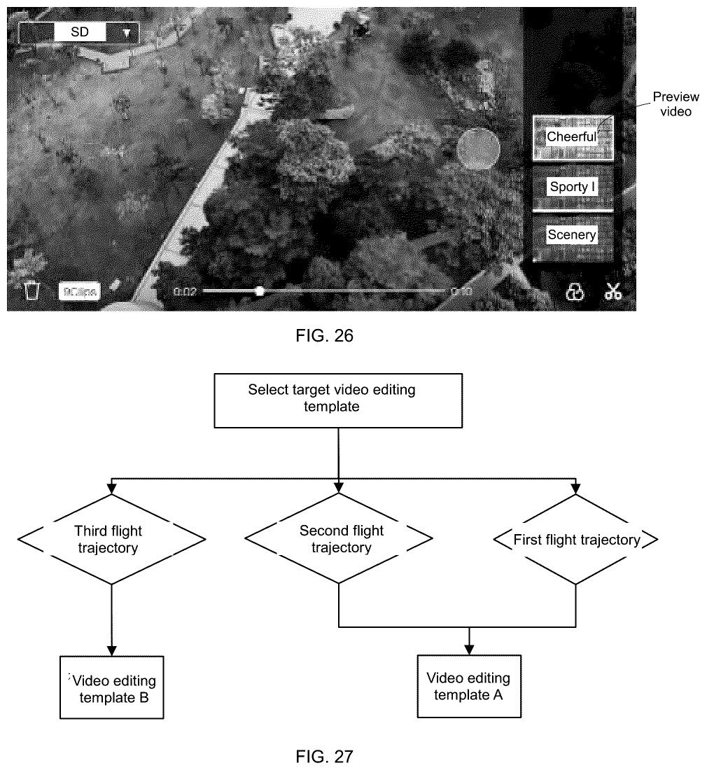

In some exemplary embodiments, referring to FIG. 26, after obtaining at least part of the video corresponding to the low-definition original video and before determining the target video editing template, the video editing device may use a preset video editing template to edit at least part of the video corresponding to the low-definition original video to obtain one or more preview videos. As shown in FIG. 26, the user may select different preview videos to play on the screen to determine whether they meet personal needs, so that the user may select a more suitable target video template.

In some exemplary embodiments, various video editing templates may be preset in the video editing device. The target video editing template may be determined from the various video editing templates. The various video editing templates may be video editing templates of different styles, and the styled may be, for example, cheerful style, sporty style, scenery style, artistic style and the like. Exemplarily, the video editing device may determine a target video editing template among multiple video editing templates based on a user selection operation.

In some exemplary embodiments, the corresponding relationship between the video editing template and the target flight trajectory may be preset in the video editing device. The video editing device may determine a target video editing template corresponding to the target flight trajectory from a plurality of video editing templates according to the target flight trajectory and the corresponding relationship. In an example, the plurality of video editing templates may match the flight mode corresponding to the target flight trajectory. The flight mode includes at least one of portrait mode, normal mode and long-distance mode. For example, referring to FIG. 27, the video editing device is preset with a video editing template A and a video editing template B. During the process of selecting the target video template, if the target flight trajectory is the portrait mode or normal mode, the target video editing template is the video editing template A. In the case where the target flight trajectory is a long-distance mode, the target video editing template is the video editing template B. Further, both the video editing template A and the video editing template B may include editing templates of different styles.

In some exemplary embodiments, considering the scheme of presetting corresponding video editing templates for at least one flight trajectory, in the case of a large number of flight trajectories, the operation of presetting the corresponding video editing templates for the flight trajectories may be quite cumbersome. In view of the foregoing, considering that each of the various flight trajectories of the UAV includes multiple sub-trajectories, the multiple sub-trajectories may be roughly divided into three types of trajectories: approaching sub-trajectories, receding sub-trajectories and encircling sub-trajectories; or they may be classified in other ways, so there is no need to preset the corresponding video editing template for the flight trajectory. Instead, the corresponding video editing templates may be set for the sub-trajectories. There may be a mapping relationship between the sub-trajectories corresponding to the needed sub-segments in the video editing template and the sub-trajectories of the flight trajectory.

In one example, as shown in Table 1, Table 1 shows the mapping numbers corresponding to various sub-trajectories in the sub-trajectory set and the three sub-trajectory types, Table 2 shows the mapping numbers corresponding to various sub-trajectories of a flight trajectory, where the approaching sub-trajectories 11, the approaching sub-trajectories 12 and the approaching sub-trajectories 13 are different sub-trajectories belonging to the same type. The sub-trajectories in Table 1 and Table 2 can be mapped by mapping numbers. The sub-trajectories corresponding to the required sub-segments of the video editing template may be selected and combined from Table 1, then the needed sub-segments of the video editing template may be obtained from the videos corresponding to various sub-trajectories of the flight trajectory by the mapping numbers in Table 1 and Table 2. For example, the sub-trajectories corresponding to the sub-segments required by the video editing template are two different approaching sub-trajectories and one encircling sub-trajectory; then the videos corresponding to the approaching sub-trajectory 11, the approaching sub-trajectory 13 and the encircling sub-trajectory 31 may be obtained from Table 2 according to the mapping numbers.

TABLE 1

| Mapping number | Sub-trajectory type |
|---|---|
| 1 | Approaching sub-trajectory |
| 2 | Receding sub-trajectory |
| 3 | Encircling sub-trajectory |

TABLE 2

| Mapping number | Sub-trajectory type |
|---|---|
| 1 | Approaching sub-trajectory 11 |
| 2 | Receding sub-trajectory 21 |
| 3 | Encircling sub-trajectory 31 |
| 1 | Approaching sub-trajectory 12 |
| 1 | Approaching sub-trajectory 13 |

In some exemplary embodiments, the target video editing template may include the time extraction intervals corresponding to each sub-segment and the splicing sequence of the sub-segments. The sub-segment is associated with the identification information stored. The identification information is used to indicate the sub-trajectory corresponding to the sub-segment. As mentioned above, the at least part of the video includes target video segments respectively corresponding to the multiple sub-trajectories. The video editing device may obtain the target video segment of the corresponding sub-trajectory according to the identification information associated with each sub-segment indicated by the target video editing template, and extract corresponding sub-segments from the target video segment according to the time extraction intervals corresponding to each sub-segment, Further, the extracted sub-segments may be spliced according to the splicing order of the sub-segments indicated by the target video editing template to obtain the target video.

Exemplarily, the splicing sequence of the sub-segments may be in accordance with the order of acquisition time of the sub-segments. Exemplarily, the splicing sequence of the sub-segments may be a combination sequence according to a predetermined sequence of video types.

Considering that the encircling sub-trajectories among the sub-trajectories usually encircle with a fixed angle relative to the target photographing object, when the distance between the starting point and the location of the target photographing object is different, the actual video duration may change. If the extraction of the original video in the video editing template is carried out with a fixed time value, misalignment or even wrong sub-trajectory extraction may occur. Therefore, the time extraction interval may be a time proportional extraction interval. A preset proportional point of the video corresponding to the sub-trajectory may be used as a reference for extraction, for example, extraction from the proportional point of ⅓ from the beginning for 3 seconds forward, or extraction from the proportional point of ¾ from the end for 5 seconds backward. The dynamic and flexible extraction of videos of different durations corresponding to different sub-trajectories in the target flight trajectory may be realized through this time-proportion-based extraction method.

In some exemplary embodiments, the type of the video corresponding to the sub-trajectory may be defined, for example, the type may include opening type, grouping type, ending type, and other deduction and summary types; or the type may include summary type, section type and other deduction types; or the type may include induction type, parallel type, comparative type, progressive type and other combination types. After randomly selecting one or more videos of each type and combining them in sequence, a target video composed of multiple shots may be obtained. Videos corresponding to the same sub-trajectory may have multiple types.

Exemplarily, various video editing templates may be preset in the video editing device. Each video editing template in the plurality of video editing templates corresponds to an opening type sub-segment, a grouping type sub-segment or an ending type sub-segment. For example, the splicing order of the sub-segments may be the video type sequence as follows: opening type sub-segment→grouping type sub-segment→ending type sub-segment.

For example, after extracting corresponding sub-segments from the target video segment according to the time extraction interval corresponding to each sub-segment indicated by the target video editing template, the video editing device may determine the type of the sub-segments corresponding to the sub-trajectory (that is, the opening type, the grouping type, and/or the ending type) according to the correspondence between the sub-trajectory and the video type, and then splicing is carried out according to the sequence of types indicated by the splicing sequence of the sub-fragments. The types of a plurality of sub-segments included in the target video may include an opening type, a grouping type and an ending type. That is, the sub-segment corresponding to the sub-trajectory may belong to at least one of the opening type sub-segment, grouping type sub-segment, and ending type sub-segment.

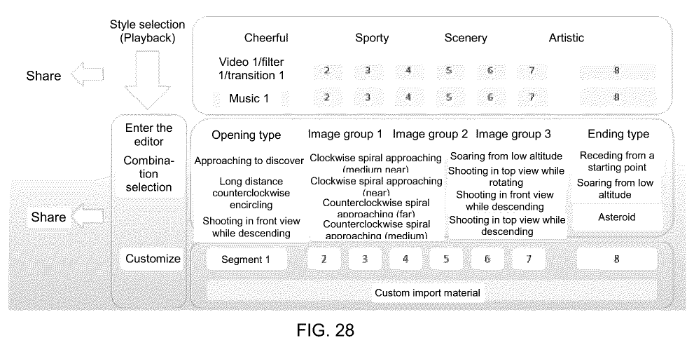

In an example, referring to FIG. 28, each video editing template indicates an opening type sub-segment, a grouping type sub-segment, and an ending type sub-segment. The sub-segments corresponding to the sub-trajectories may belong to at least one of the opening type sub-segment, the grouping type sub-segment and the ending type sub-segment. That is, the sub-segments corresponding to the sub-trajectories may belong to multiple types. Classifying the second flight trajectory according to the opening type-grouping type-ending type, there are: opening type: (2) long-distance encircling, (3) approaching to discover, (8) shooting in front view while descending; grouping type: combination 1: (5.1) clockwise spiral approaching (medium near), (5.2) clockwise spiral approaching (near); combination 2: (2) counterclockwise spiral approaching (far), (4) counterclockwise spiral approaching (medium); combination 3: (6) soaring from low altitude, (7) shooting in top view while rotating; combination 4: (8) shooting in front view while descending, (9) shooting in top view while descending; ending type: (1) receding from a starting point, (6) soaring from low altitude. For example, referring to FIG. 28, the video editing template may also include music. When editing each sub-segment, it may be filled with segment grids divided according to the music beat, then extract a sub-segment of the opening type and fill it in a first grid, then extract a sub-segment of the ending type and fill it in the last grid, and then one or more grouping type sub-segments are extracted and filled in the remaining grids in the middle so as to obtain the target video.

In addition, the video editing template may also include filters, special effects (transition effects), etc., so as to generate an ornamental and logical target video. Different styles and video editing templates correspond to different music, filters, and transitions. The segments randomly selected according to the video type may be different each time. The target photographing object of each shooting may also be different, so the target video obtained by this editing scheme is different every time. While ensuring the effect of filming, it may also meet the individual needs of various users. In addition, the classification of the above video types (opening, grouping and ending) has no effect on the flight sequence of each sub-trajectory in the flight route of the UAV. For example, the flight paths shown in FIGS. 18 to 20 may be composed of sub-trajectories 0 to 9 executed in such a sequence.

Of course, the user may also directly select a specified sub-segment in a certain type for secondary editing, or click on a sub-segment to manually adjust the specific interval for the original segment. In the process of automatic flight shooting, users may mark a sub-trajectory as favorite, or directly mark the favorite interval, so that it can be actually used in post-editing.

In the post-editing process, the user may choose to use one target flight trajectory to automatically form a video, or choose this function to use multiple videos of multiple target flight trajectories to automatically form a video. The target photographing objects corresponding to the multiple target flight trajectories can be different. So, this method has high scalability. In some exemplary embodiments, if the UAV is interrupted during its flight according to the target flight trajectory (for example, the interruption may be caused by user operation or obstacle avoidance) and does not continue to fly according to the target flight trajectory, the video editing device may obtain at least part of the video corresponding to each sub-trajectory that has been taken by the photographing device, and then use the target editing template to edit the at least part of the video to obtain the target video. The video editing device may perform frame extraction processing on the video corresponding to the first sub-trajectory in the target flight trajectory to obtain the target video. Exemplarily, the video editing device may determine an interrupted path in the moving route of the target, and then a target video template is selected from multiple candidate video templates according to the interrupted path.

In some exemplary embodiments, the video device may also obtain a video captured by a handheld photographing device. For example, the handheld photographing device may be mounted on a gimbal. The video photographing device may automatically edit the at least part of the video and the video taken by the handheld photographing device according to the target video editing template to obtain the target video, so as to realize that videos shot by different devices can be integrated and edited to obtain a good film effect.

In some exemplary embodiments, the target video may be displayed by a display device of the terminal device; the user may also choose to share the target video to a social platform or save it locally.

The flight control method and the video editing method provided herein may realize the automatic recognition of the type of the target photographing object by the UAV. Multiple videos and/or multiple photos taken in different ways may be obtained in a single flight, and then automatically edited according to the preset video editing templates, and finally get an ornamental and logical video composed of multiple lens images, which can be added with music, filters, transition effects, etc. It greatly improves the efficiency and quality of the entire process of flight, shooting, and editing, and brings users a brand-new interactive experience.

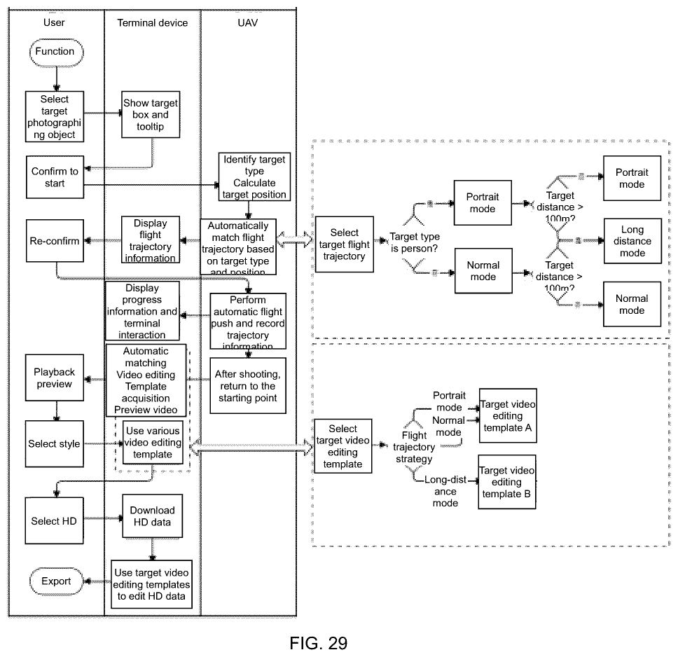

In some exemplary embodiment, referring to FIG. 29, for example, the flight control device is installed on the UAV and the video editing device is installed on the terminal device. FIG. 29 shows the interaction process between the user, the terminal device and the UAV. A full-process interactive solution of automatic flight and automatic editing is adopted herein, and only certain key steps involve manual operation. Therefore, it achieves the effect of one-click shooting and one-click filming, which lowers the threshold for use.

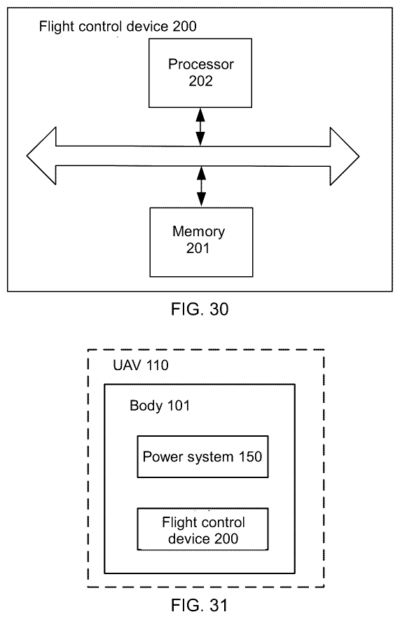

Correspondingly, referring to FIG. 30, some exemplary embodiments of the present application also provide a flight control device 200, which includes:
a memory 201 for storing executable instructions;
one or more processors 202;
where when the one or more processors 202 execute the executable instructions, they are individually or jointly configured to perform the following:
obtaining a type of a target photographing object of a photographing device and/or a distance between the target photographing object and the UAV;
determining a target flight trajectory among a plurality of flight trajectories based on the type of the target photographing object and/or the distance between the target photographing object and the UAV; and
controlling the UAV to fly according to the target flight trajectory, and using the photographing device to photograph the target photographing object.

In some exemplary embodiments, the processor 202 is further configured to perform: according to whether the type of the target photographing object is a person type and/or a result of comparing the distance between the target photographing object and the UAV with a preset distance threshold, determining the target flight trajectory among the plurality of flight trajectories.

In some exemplary embodiments, the plurality of flight trajectories include at least one of a first flight trajectory corresponding to a portrait mode, a second flight trajectory corresponding to a normal mode, and a third flight trajectory corresponding to a long-distance mode.

In some exemplary embodiments, the processor 202 is further configured to perform: if the type of the target photographing object is a person type, determining the target flight trajectory to be the first flight trajectory.

In some exemplary embodiments, the processor 202 is further configured to perform: if the distance between the target photographing object and the UAV is greater than the preset distance threshold, determining the target flight trajectory to be the third flight trajectory.

In some exemplary embodiments, the processor 202 is further configured to perform:
if the type of the target photographing object is a person type and the distance between the target photographing object and the UAV is less than the preset distance threshold, determining the target flight trajectory to be the first flight trajectory;
if the type of the target photographing object is a person type and the distance between the target photographing object and the UAV is greater than or equal to the preset distance threshold, determining the target flight trajectory to be the second flight trajectory;
if the type of the target photographing object is not a person type and the distance between the target photographing object and the UAV is less than the preset distance threshold, determining the target flight trajectory to be the second flight trajectory;
if the type of the target photographing object is not a person type and the distance between the target photographing object and the UAV is greater than or equal to the preset distance threshold, determining the target flight trajectory to be the third flight trajectory.

In some exemplary embodiments, a relative positional relationship between a target starting point of the first flight trajectory corresponding to the portrait mode and the target photographing object satisfies a preset condition.

In some exemplary embodiments, when the photographing device photographs the target photographing object at the target starting point, the target photographing object is at a preset position in a photographing frame and/or has a preset size.

In some exemplary embodiments, the preset condition includes at least one of the following: a height difference between the target starting point and the target photographing object is a preset height; or a horizontal distance between the target starting point and the target photographing object is a preset horizontal distance.

In some exemplary embodiments, each of the plurality of flight trajectories includes a plurality of sub-trajectories.

In some exemplary embodiments, combinations of the sub-trajectories corresponding to various flight trajectories are different.

In some exemplary embodiments, the plurality of sub-trajectories includes the first sub-trajectory, and the processor 202 is further configured to perform: during a flight process of the UAV according to the first sub-trajectory, controlling a pitch angle of the photographing device to rotate from a first pitch angle to a second pitch angle, where when the pitch angle of the photographing device is at the first pitch angle, the target photographing object is outside the photographing frame of the photographing device, and when the pitch angle of the photographing device is at the second elevation angle, the target photographing object is within the photographing frame of the photographing device.

In some exemplary embodiments, the plurality of sub-trajectories includes the second sub-trajectory, and the processor 202 is further configured to perform:
during a flight process of the UAV according to the second sub-trajectory, controlling the UAV to rotate by a yaw angle and the photographing device to face vertically downward.

In some exemplary embodiments, the plurality of sub-trajectories includes the third sub-trajectory, and the processor 202 is further configured to perform: during a flight process of the UAV according to the third sub-trajectory, controlling the UAV to fly in a direction toward the target photographing object or in a direction away from the target photographing object and the photographing device to rotate by a roll angle.

In some exemplary embodiments, the plurality of sub-trajectories includes a fourth sub-trajectory, and the processor 202 is further configured to perform:
during a flight process of the UAV according to the fourth sub-trajectory, controlling the UAV to fly in a direction toward the target photographing object and changing a focal length of the photographing device from the longest focal length to the widest focal length; or
during a flight process of the UAV according to the fourth sub-trajectory, controlling the UAV to fly in a direction away from the target photographing object and changing the focal length of the photographing device from the widest focal length to the longest focal length.

In some exemplary embodiments, the plurality of sub-trajectories includes a fifth sub-trajectory, and the processor 202 is further configured to perform:
during a flight process of the UAV according to the fifth sub-trajectory, controlling the to encircle the target photographing object based on an inner spiral route and the photographing device to face the target photographing object to form a preset angle with a direction of a nose of the UAV.

In some exemplary embodiments, the processor 202 is further configured to perform: during the flight of the UAV according to the target flight trajectory, if an obstacle is detected, controlling the UAV to avoid the obstacle according to the first detour trajectory or the second detour trajectory, where a starting point and an ending point of the first detour trajectory are both within the sub-trajectory where the UAV is currently located, a starting point of the second detour trajectory is within the sub-trajectory where the UAV is currently located, and the ending point of the second detour trajectory is within a next sub-trajectory of the sub-trajectory at which the UAV is currently located.

In some exemplary embodiments, sizes of flight areas corresponding to the various flight trajectories are different.

In some exemplary embodiments, flight times corresponding to the plurality of flight trajectories are different.

In some exemplary embodiments, the UAV is in communication with a terminal device, and processor 202 is further configured to perform: sending the target flight trajectory to the terminal device, so that a display device of the terminal device superimposes and displays the target flight trajectory, a flight area corresponding to the target flight trajectory, and a map corresponding to the target flight trajectory.

In some exemplary embodiments, the processor 202 is further configured to perform: the target flight trajectory is adjusted according to trajectory adjustment information, where the trajectory information is generated based on a user operation on the terminal device.

In some exemplary embodiments, the flight trajectory adjustment information includes flight area adjustment information, and the operation includes adjusting the size of the flight area displayed on the display device, and the flight area is a 2D area or a 3D area.

In some exemplary embodiments, the processor 202 is further configured to perform: during a flight process of the UAV according to the target flight trajectory, sending real-time position and flight direction of the UAV to the terminal device, so that the display device of the terminal device superimposes and displays the real-time position and flight direction on the map corresponding to the target flight trajectory.

In some exemplary embodiments, the target flight trajectory includes a plurality of sub-trajectories, and the display device of the terminal device is further configured to display the sub-trajectory corresponding to the real-time position among the plurality of trajectories.

In some exemplary embodiments, the display device of the terminal device is also configured to display a remaining flight time of the UAV flying according to the target flight trajectory.

Correspondingly, some exemplary embodiments of the present application also provide a flight control device, which includes:
a memory for storing executable instructions;
one or more processors;
where when the one or more processors execute the executable instructions, they are individually or jointly configured to perform:
obtaining a target flight trajectory of the UAV, where the target flight trajectory includes a plurality of sub-trajectories, and the plurality of sub-trajectories include an encircling sub-trajectory, an approaching sub-trajectory, and/or a receding sub-trajectory;
controlling the UAV to fly according to the target flight trajectory, and using a photographing device of the UAV to photographing a target photographing object.

In some exemplary embodiments, the processor is also configured to perform: obtaining a type of the target photographing object of the photographing device and/or a distance between the target photographing object and the UAV; and determining the target flight trajectory among various flight trajectories according to the type of the target photographing object and/or the distance between the target photographing object and the UAV.

In some exemplary embodiments, the plurality of sub-trajectories further includes the first sub-trajectory, and the processor is configured to perform: during the flight of the UAV according to the first sub-trajectory, controlling a pitch angle of the photographing device to rotate from a first pitch angle to a second pitch angle, where when the pitch angle of the photographing device is at the first pitch angle, the target photographing object is outside a photographing frame of the photographing device, and when the pitch angle of the photographing device is at the second pitch angle, the target photographing object is within the photographing frame of the photographing device.

In some exemplary embodiments, the plurality of sub-trajectories further includes the second sub-trajectory, and the processor is configured to perform: during the flight of the UAV according to the second sub-trajectory, controlling the UAV to rotate a yaw angle and the photographing device to face vertically downward.

In some exemplary embodiments, the plurality of sub-trajectories further includes the third sub-trajectory, and the processor is configured to perform: during the flight of the UAV according to the third sub-trajectory, controlling the UAV to fly in a direction toward the target photographing object or in a direction away from the target photographing object, and controlling the photographing device to rotate a rolling angle.

In some exemplary embodiments, the plurality of sub-trajectories further includes a fourth sub-trajectory, and the processor is configured to perform: during the flight of the UAV according to the fourth sub-trajectory, controlling the UAV to fly in a direction toward the target photographing object, and changing a focal length of the photographing device from the longest focal length to the widest focal length; or during the flight of the UAV according to the fourth sub-trajectory, controlling the UAV to fly in a direction away from the target photographing object, and changing the focal length of the photographing device from the widest focal length to the longest focal length.

In some exemplary embodiments, the plurality of sub-trajectories further includes a fifth sub-trajectory, and the processor is configured to perform: during the flight of the UAV according to the fifth sub-trajectory, controlling the UAV to encircle the target photographing object based on an inner spiral route, the photographing device facing the target photographing object and forming a preset angle with a direction of the nose of the UAV.

In some exemplary embodiments, the processor is configured to perform: during the flight of the UAV according to the target flight trajectory, if an obstacle is detected, controlling the UAV to avoid the obstacle through a first detour trajectory or a second detour trajectory, where a starting point and an ending point of the first detour trajectory are both within a sub-trajectory where the UAV is currently located, the starting point of the second detour trajectory is within a sub-trajectory where the UAV is currently located, and the ending point of the second detour trajectory is within a sub-trajectory following the sub-trajectory where the UAV is currently located.

Correspondingly, some exemplary embodiments of the present application also provides a flight control device, which includes:
a memory for storing executable instructions;
one or more processors;
where when the one or more processors execute the executable instructions, they are individually or jointly configured to perform:
obtaining a type of a target photographing object of a photographing device;
if the type of the target photography object of the photographing device on a UAV is a person type, controlling the UAV to fly to a target starting point, so that the UAV takes the target starting point as a starting point to photograph the target photography object,
where a relative positional relationship between the target starting point and the target photographing object satisfies a preset condition.

In some exemplary embodiments, when the photographing device photographs the target photographing object at the target starting point, the target photographing object is at a preset position in a photographing frame and/or has a preset size.

In some exemplary embodiments, the preset condition includes at least one of the following: a height difference between the target starting point and the target photographing object is a preset height; or a horizontal distance between the target starting point and the target photographing object is a preset horizontal distance.

In some exemplary embodiments, if the type of the target photographing object of the photographing device is a person type, and the distance between the target photographing object and the UAV is less than a preset distance threshold, controlling the UAV to fly to the target starting point.

In some exemplary embodiments, the processor is further configured to perform: controlling the UAV to fly from the target starting point according to the target flight trajectory, and using the photographing device to photograph the target photographing object.

Correspondingly, some exemplary embodiments of the present application also provides a flight control device, which includes:
a memory for storing executable instructions;
one or more processors;
where when the one or more processors execute the executable instructions, they are individually or jointly configured to perform:
obtaining a distance between a target photographing object and a UAV;
if the distance between the target photographing object and the UAV is greater than a preset threshold, when the UAV encircles the target photographing object, controlling the UAV to encircle the target photographing object based on an inner spiral route,
where the photographing device of the UAV faces the target photographing object and forms a preset angle with a direction of a nose of the UAV.

In some exemplary embodiments, the photographing device is mounted on the UAV via a gimbal, the gimbal has a rotation limit, and the setting of the preset threshold is related to the rotation limit.

In some exemplary embodiments, the nose of the UAV is provided with an environmental sensing device, and a direction of the environmental sensing device is consistent with the direction of the nose.

In some exemplary embodiments, the processor is further configured to perform: if the distance between the target photographing object and the UAV is less than the preset threshold, when the UAV encircles the target photographing object, controlling the UAV to encircle the target photographing object based on a circular route.

Correspondingly, referring to FIG. 31. In the case where the flight control device includes a chip or an integrated circuit, some exemplary embodiments of the present disclosure also provides a UAV 110, including:
a body 101;
a power system 150 arranged on the body 101 to provide a power for the UAV; and

a flight control device 200 as described above.

Correspondingly, some exemplary embodiments of the present disclosure also provides a video editing device, the device includes:
a memory for storing executable instructions;
one or more processors;
where when the one or more processors execute the executable instructions, they are individually or jointly configured to perform:
obtaining at least part of a video captured by a photographing device when the UAV flies according to at least one target flight trajectory, the target flight trajectory includes a plurality of sub-trajectories;
automatically editing the at least part of the video according to a target video editing template to obtain a target video, the target video includes a plurality of sub-segments, and at least two sub-segments in the plurality of sub-segments correspond to different sub-trajectories in the plurality of sub-trajectories.

In some exemplary embodiments, each sub-segment in the plurality of sub-segments is associated with stored identification information, and the identification information is configured to indicate a sub-trajectory corresponding to the sub-segment.

In some exemplary embodiments, the target video editing template includes a time extraction interval corresponding to each sub-segment and a splicing sequence of the sub-segments.

In some exemplary embodiments, the time extraction interval is a time proportional extraction interval.

In some exemplary embodiments, the processor is further configured to perform: determining a target video editing template among a plurality of video editing templates based on a user selection operation.

In some exemplary embodiments, types of the plurality of sub-segments include an opening type, a grouping type, and an ending type.

Each video editing template in the plurality of video editing templates corresponds to a different opening-type sub-segment, a grouping-type sub-segment, or an ending-type sub-segment.

In some exemplary embodiments, the plurality of video editing templates match a flight mode(s) corresponding to the target flight trajectory, and the flight mode(s) includes at least one of a portrait mode, a normal mode, and a long-distance mode.

In some exemplary embodiments, the processor is also configured to perform: receiving real-time image transmission data sent by the UAV when the UAV flies according to the target flight trajectory, so as to obtain a low-definition original video; and removing video segments corresponding to a beginning or end of at least one sub-trajectory in the plurality of sub-trajectories to obtain the at least part of the video.

In some exemplary embodiments, the processor is also configured to perform: receiving high-definition image transmission data sent by the UAV after flying according to the target flight trajectory, so as to obtain the at least part of the video, where the video segment corresponding to the beginning or the end of at least one sub-trajectory in the plurality of sub-trajectories has been removed from the at least part of the video.

In some exemplary embodiments, the processor is also configured to perform: if the UAV is interrupted while flying according to the target flight trajectory, performing frame extraction processing on a video corresponding to the first sub-trajectory in the target flight trajectory to obtain the target video.

In some exemplary embodiments, the processor is also configured to perform: obtaining a video captured by a handheld photographing device; and automatically editing the at least part of the video and the video shot by the handheld photographing device according to the target video editing template to obtain the target video.

In some exemplary embodiments, the video editing device includes a terminal device, a server, and the like. As for the device embodiments, since they basically correspond to the method embodiments, for related parts, please refer to the description of the method embodiments. Various exemplary embodiments described herein can be implemented using a computer readable medium such as computer software, hardware, or any combination thereof. For hardware implementation, the implementation described herein can be implemented by at least one of Application Specific Integrated Circuit (ASIC), Digital Signal Processor (DSP), Digital Signal Processing Device (DSPD), Programmable Logic Device (PLD), Field Programmable Gate Array (FPGA), processors, controllers, microcontrollers, microprocessors, electronic units designed to perform the functions described herein. For software implementation, a procedure or a function may be implemented with a separate software module that allows at least one function or operation to be performed. The software code may be implemented by a software application (or program) written in any suitable programming language. Software codes can be stored in a memory and executed by a controller.

In some exemplary embodiments, also provided is a non-transitory computer-readable storage medium with instructions, such as a memory including instructions executable by a processor of an apparatus to perform the above methods. For example, the non-transitory computer readable storage medium may be ROM, random access memory (RAM), CD-ROM, magnetic tape, floppy disk, and optical data storage device, etc.

For the non-transitory computer-readable storage medium, when instructions in the storage medium are executed by a processor of the terminal, the terminal can execute the above methods.

It should be noted that in this disclosure, relational terms such as first and second are only used to distinguish one entity or operation from another entity or operation, and do not necessarily require or imply that there is such a relationship or sequence between these entities or operations. The term “comprising,” “including” or any other variation thereof is intended to cover a non-exclusive inclusion such that a process, a method, an article or an apparatus including a set of elements may include not only those elements but also other elements not explicitly listed, or elements inherent in such a process, method, article, or apparatus. Without further limitations, an element defined by the phrase “comprising a . . . ” does not exclude the presence of additional identical elements in the process, method, article or apparatus including the element.

The methods and devices provided in the exemplary embodiments of the present disclosure have been described in detail above. Herein, specific examples are used to illustrate the principles and implementations of the disclosure. The description of the above embodiments is only used to help understand the methods and core ideas of the present disclosure. At the same time, for a person of ordinary skill in the art, according to the ideas of the present disclosure, there may be changes in the specific implementations and application scopes. Therefore, the contents of this disclosure should not be understood as limiting the scope of the disclosure.

What is claimed is:

1. A flight control method for a movable platform with a photographing device, comprising:
obtaining at least one of a type of a target photographing object of the photographing device or a distance between the target photographing object and the movable platform;
determining a target flight trajectory among a plurality of flight trajectories based on at least one of the type of the target photographing object or the distance between the target photographing object and the movable platform; and
controlling the movable platform to fly according to the target flight trajectory, and using the photographing device to photograph the target photographing object.

2. The method according to claim 1, wherein the determining of the target flight trajectory among the plurality of flight trajectories based on the at least one of the type of the target photographing object or the distance between the target photographing object and the movable platform includes:
determining the target flight trajectory among the plurality of flight trajectories according to at least one of whether the type of the target photographing object is a person type or a result of comparing the distance between the target photographing object and the movable platform with a preset distance threshold.

3. The method according to claim 2, wherein the plurality of flight trajectories includes at least one of a first flight trajectory corresponding to a portrait mode, a second flight trajectory corresponding to a normal mode, and a third flight trajectory corresponding to a long-distance mode.

4. The method according to claim 3, wherein the determining of the target flight trajectory among the plurality of flight trajectories based on the at least one of the type of the target photographing object or the distance between the target photographing object and the movable platform includes:
upon determining the type of the target photographing object to be a person type, determining the target flight trajectory to be the first flight trajectory.

5. The method according to claim 3, wherein the determining of the target flight trajectory among the plurality of flight trajectories based on the at least one of the type of the target photographing object or the distance between the target photographing object and the movable platform includes:
upon determining that the distance between the target photographing object and the movable platform is greater than the preset distance threshold, determining the target flight trajectory to be the third flight trajectory.

6. The method according to claim 3, wherein the determining, according to at least one of whether the type of the target photographing object is the person type or the result of comparing the distance between the target photographing object and the movable platform with a preset distance threshold, the target flight trajectory among the plurality of flight trajectories includes:
upon determining that the type of the target photographing object is a person type and that the distance between the target photographing object and the movable platform is less than the preset distance threshold, determining the target flight trajectory to be the first flight trajectory;
upon determining that the type of the target photographing object is a person type and that the distance between the target photographing object and the movable platform is greater than or equal to the preset distance threshold, determining the target flight trajectory to be the second flight trajectory;
upon determining that the type of the target photographing object is not a person type and that the distance between the target photographing object and the movable platform is less than the preset distance threshold, determining the target flight trajectory to be the second flight trajectory; and
upon determining that the type of the target photographing object is not a person type and that the distance between the target photographing object and the movable platform is greater than or equal to the preset distance threshold, determining the target flight trajectory to be the third flight trajectory.

7. The method according to claim 3, wherein a relative positional relationship between a target starting point of the first flight trajectory corresponding to the portrait mode and the target photographing object satisfies a preset condition.

8. The method according to claim 7, wherein when the photographing device photographs the target photographing object at the target starting point, the target photographing object at least is at a preset position in a photographing frame or has a preset size.

9. The method according to claim 7, wherein the preset condition includes at least one of the following:
a height difference between the target starting point and the target photographing object is a preset height; or
a horizontal distance between the target starting point and the target photographing object is a preset horizontal distance.

10. The method according to claim 1, wherein each of the plurality of flight trajectories includes a plurality of sub-trajectories.

11. The method according to claim 10, wherein each of the plurality of flight trajectories corresponds to a different combination of the sub-trajectories.

12. The method according to claim 10, further comprising:
determining the plurality of sub-trajectories includes a first sub-trajectory; and
during a flight process of the movable platform according to the first sub-trajectory, adjusting a pitch angle of the photographing device from a first pitch angle to a second pitch angle, wherein
when the pitch angle of the photographing device is the first pitch angle, the target photographing object is outside the a photographing frame of the photographing device, and when the pitch angle of the photographing device is the second elevation angle, the target photographing object is within the photographing frame of the photographing device.

13. The method according to claim 10, further comprising:
determining the plurality of sub-trajectories includes a second sub-trajectory; and
during a flight process of the movable platform according to the second sub-trajectory, controlling the movable platform to rotate a yaw angle and the photographing device to face vertically downward.

14. The method according to claim 10, further comprising:
determining the plurality of sub-trajectories includes a third sub-trajectory; and
during a flight process of the movable platform according to the third sub-trajectory, controlling the movable platform to fly toward the target photographing object or to fly away from the target photographing object, and controlling the photographing device to rotate a roll angle.

15. The method according to claim 10, further comprising:
determining the plurality of sub-trajectories includes a fourth sub-trajectory; and
during a flight process of the movable platform according to the fourth sub-trajectory, controlling the movable platform to fly toward the target photographing object and adjusting a focal length of the photographing device from a longest focal length to a widest focal length; or
during a flight process of the movable platform according to the fourth sub-trajectory, controlling the movable platform to fly away from the target photographing object and adjusting a focal length of the photographing device from a widest focal length to a longest focal length.

16. The method according to claim 10, further comprising:
determining the plurality of sub-trajectories includes a fifth sub-trajectory; and
during a flight process of the movable platform according to the fifth sub-trajectory, controlling the movable platform to encircle the target photographing object based on an inner spiral route, and controlling the photographing device to face the target photographing object and form a preset angle with a nose direction of the movable platform.

17. The method according to claim 10, further comprising:
during a flight process of the movable platform according to the target flight trajectory, upon detecting an obstacle, controlling the movable platform to avoid the obstacle through a first detour trajectory or a second detour trajectory, wherein
a starting point and an ending point of the first detour trajectory are within a sub-trajectory where the movable platform is currently located, a starting point of the second detour trajectory is within the sub-trajectory where the movable platform is currently located, and an ending point of the second detour trajectory is within a sub-trajectory following the sub-trajectory where the movable platform is currently located.

18. The method according to claim 1, further comprising:
establishing a communication between the movable platform and a terminal device; and
sending the target flight trajectory to the terminal device to enable a display device of the terminal device to superimpose and display the target flight trajectory, a flight area corresponding to the target flight trajectory, and a map corresponding to the target flight trajectory.

19. A flight control method for a movable platform with a photographing device, comprising:
obtaining a type of a target photographing object of the photographing device; and
upon determining that the type of the target photographing object is a person type, controlling the movable platform to fly to a target starting point to allow the movable platform to take the target starting point as a starting point to photographing the target photographing object,
wherein a relative positional relationship between the target starting point and the target photographing object satisfies a preset condition.

20. A flight control method for a movable platform with a photographing device, comprising:
obtaining a distance between the target photographing object and the movable platform; and
upon determining that a distance between the target photographing object and the movable platform is greater than a preset threshold, when the movable platform encircles the target photographing object, controlling the movable platform to encircle the target photographing object based on an inner spiral course, wherein
the photographing device faces the target photographing object and forms a preset angle with a nose direction of the movable platform.
